(19) United States
(12) Patent Application Publication
(10) Pub. No.: US 2023/0216563 A1
(43) Pub. Date: Jul. 6, 2023

(54) METHOD AND DEVICE IN NODES USED FOR WIRELESS COMMUNICATION

(71) Applicants: Qi JIANG, Shanghai (CN); Xiaobo ZHANG, Shanghai (CN)

(72) Inventors: Qi JIANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/120,437

(22) Filed: Mar. 13, 2023

Related U.S. Application Data
(63) Continuation of application No. PCT/CN2021/118435, filed on Sep. 15, 2021.

(30) Foreign Application Priority Data
Sep. 21, 2020 (CN) 202010993570.0
Sep. 27, 2020 (CN) 202011032439.4

(51) Int. Cl. H04B 7/06; H04W 74/08; H04L 1/00; H04L 5/00; H04W 56/00

(52) U.S. Cl. CPC H04B 7/0617; H04L 1/0061; H04L 5/0048; H04W 56/0045; H04W 74/0833

(57) ABSTRACT

The present application discloses a method and a device in a node for wireless communications. A node firstly transmits a first characteristic sequence and a target signal; and monitors a first signaling in a first time window; and when the first signaling is detected, demodulates a first signal; a channel occupied by the first characteristic sequence includes a RA-related channel; the target signal comprises a first identifier, while the first signal comprises the first identifier and a second identifier, and CRC comprised in the first signaling is scrambled by a third identifier; the first signaling indicates the first signal; the target signal is used to trigger the first signal; the first identifier and the second identifier are respectively C-RNTIs, and the third identifier is different from the first identifier. This application optimizes the method and device for physical-layer mobility management under beamforming with an intent of improving positioning performance.

### CROSS REFERENCE TO RELATED APPLICATIONS

This application is the continuation of the international patent application No.PCT/CN2021/118435, filed on September 15,2021, which claims the priority benefit of Chinese Patent Application No.202010993570.0, filed on September 21,2020; and claims the priority benefit of Chinese Patent Application No.202011032439.4, filed on September 27,2020, the full disclosure of which is incorporated herein by reference.

### BACKGROUND

### Technical Field

The present application relates to transmission methods and devices in wireless communication systems, and in particular to a scheme and device for transmission of radio signals used for cell handover in wireless communications.

### Related Art

In LTE systems, inter-cell handover is controlled by a base station based on measurements of a User Equipment (UE). And the inter-cell handover in the 3rd Generation Partner Project (3GPP) Release (R) 15 basically adopts the mechanism used in the LTE. As for a New Radio (NR) system, more application scenarios need to be supported. Some scenarios, such as Ultra-Reliable and Low Latency Communications (URLLC), have posed high demands on the delay, and new challenges are also presented against inter-cell handover.

In the NR system, Massive Multiple Input Multiple Output (MIMO) is a significant technical feature. In Massive MIMO, multiple antennas form through beamforming a narrow beam pointing in a specific direction to enhance communication quality. Since the beam formed by multiple antennas through beamforming is generally narrow, beams from both sides of communications are required to be aligned for performing effective communications.

### SUMMARY

Inventors find through researches that beam-based communications will have negative influence on inter-cell handover, such as extra delay and pingpong effect. Then how to reduce the negative impact, speed up the terminal handover and go deeper in improving the performance of users at the cell boundary to meet various demands of application scenarios is an issue remaining to be solved.

To address the above problem, the present application provides a solution. It should be noted that though the present application only took the massive MIMO and beam-based communications as a typical or exemplary scenario in the statement above, it is also applicable to other scenarios such as LTE multi-antenna system, where similar technical effects can be achieved. Additionally, the adoption of a unified solution for various scenarios, including but not limited to massive MIMO, beam-based communications, and LTE multi-antenna system, contributes to the reduction of hardcore complexity and costs. In the case of no conflict, the embodiments of any node and the characteristics in the embodiments may be applied to any other node, and vice versa. What’s more, the embodiments in the present application and the characteristics in the embodiments can be arbitrarily combined if there is no conflict.

To address the above problem, the present application provides a method and a device for Layer ½ (L1/L2) inter-cell handover and mobility management. It should be noted that if no conflict is incurred, embodiments in a User Equipment (UE) in the present application and the characteristics of the embodiments are also applicable to a base station, and vice versa. What’s more, the embodiments in the present application and the characteristics in the embodiments can be arbitrarily combined if there is no conflict. Further, though originally targeted at cellular networks, the present application also applies to the Internet of Things (IoT) and Vehicle-to-Everything (V2X). Further, though originally targeted at multicarrier communications, the present application also applies to single-carrier communications. Further, though originally targeted at multi-antenna communications, the present application also applies to single-antenna communications. Further, the present application is designed targeting terminal-base station scenario, but can be extended to inter-terminal communications, terminal-relay communications, as well as relay-base station communications, where similar technical effects can be achieved. Additionally, the adoption of a unified solution for various scenarios, including but not limited to terminal-base station communications, contributes to the reduction of hardcore complexity and costs.

Furthermore, if no conflict is incurred, embodiments in the first node in the present application and the characteristics of the embodiments are also applicable to a second node, and vice versa. Particularly, for interpretations of the terminology, nouns, functions and variants (unless otherwise specified) in the present application, refer to definitions given in TS36 series, TS38 series and TS37 series of 3GPP specifications.

The present application provides a method in a first node for wireless communications, comprising:
transmitting a first characteristic sequence and a target signal; and
monitoring a first signaling in a first time window; and when the first signaling is detected, demodulating a first signal;
herein, a channel occupied by the first characteristic sequence includes a random access (RA)-related channel, a transmission timing of the target signal is related to a transmission timing of the first characteristic sequence; the target signal comprises a first identifier, while the first signal comprises the first identifier and a second identifier, and Cyclic Redundancy Check (CRC) comprised in the first signaling is scrambled by a third identifier; the first signaling comprises configuration information of the first signal, the configuration information comprising a time-frequency resource set occupied by the first signal; the target signal is used to trigger the first signal; the first identifier is a Cell-Radio Network Temporary Identity (C-RNTI), the second identifier is a C-RNTI, and the third identifier is a Radio Network Temporary Identifier (RNTI) different from the first identifier; the first time window is related to a time-domain resource occupied by the target signal.

In one embodiment, a technical feature of the above method lies in that: when the first node triggers a handover due to a Beam Link Failure (BLF), in order to increase the speed of handover and avoid interaction with L3, the first node will directly initiate a random access to a target cell to which it is supposed to be switched, hence the avoidance of the triggering of measurement reporting and subsequent interactions between the current serving cell and the target cell, and an enhancement in handover efficiency and rate.

In one embodiment, another technical feature of the above method lies in that: since the first node hasn’t established a Radio Resource Control (RRC) connection to a target cell, the first node will recommend a beam to the target cell by means of random access and, in the meantime, transmit to the target cell a C-RNTI already allocated to the first node in an original cell, that is, the first identifier; and then the target cell will send the C-RNTI allocated to the original cell via the first signal as feedback to the first node, which notifies the first node of the fact that the target signal is correctly received by the target cell.

In one embodiment, a third technical feature of the above method lies in that: when transmitting a C-RNTI assigned to an original cell the target cell also distributes a new C-RNTI assigned to the target cell, i.e., a second identifier to the first node, hence the completion of handover.

According to one aspect of the present application, the first characteristic sequence and the target signal belong to a same message MSGA, with the third identifier being a MSGB-RNTI.

In one embodiment, a technical feature of the above method lies in that: it can be applied in a 2-step random access procedure.

According to one aspect of the present application, comprising:
receiving a third signal after the first characteristic sequence is transmitted and before the target signal is transmitted;
herein, the first characteristic sequence is used to trigger the third signal, the third signal indicating the third identifier.

According to one aspect of the present application, the first identifier is configured by a first cell, while the second identifier and third identifier are configured by a second cell, the first cell being different from the second cell; a first radio resource is used to determine a first reference signal resource, the first radio resource comprising at least one of a time-domain resource occupied by the first characteristic sequence, a frequency-domain resource occupied by the first characteristic sequence or a preamble index of the first characteristic sequence; or, the target signal comprises a first information element, the first information element in the target signal being used to indicate a first reference signal resource; the first reference signal resource is maintained by the second cell.

According to one aspect of the present application, comprising:
receiving a first information block, the first information block being used to indicate M1 candidate reference signal resources; and
selecting the first reference signal resource from the M1 candidate reference signal resources;
herein, the first reference signal resource is a candidate reference signal resource among the M1 candidate reference signal resources; a transmitter of the first information block is the first cell; M1 is a positive integer greater than 1.

In one embodiment, a technical feature of the above method lies in that: the M1 candidate reference signal resources respectively correspond to M1 beams maintained by a target cell, a current serving cell forwards the first information block for notifying the target cell next to the first node of beam configuration, so that the first node can detect and report a beam of the neighboring target cell as a candidate beam to ensure smooth completion of L1/L2 handover.

According to one aspect of the present application, comprising:
receiving a second information block, the second information block indicating a target reference signal resource group; and
measuring the target reference signal resource group, where a channel quality of each reference signal resource in the target reference signal resource group is lower than a first threshold, and a first counter is incremented by 1;
herein, the target reference signal resource group comprises at least one reference signal resource, the first counter reaches a first trigger value, and a transmission of the first characteristic sequence is triggered.

In one embodiment, a technical feature of the above method lies in that: reference signal resources corresponding to the target reference signal resource group are multiple beams maintained by an original serving cell, only when the channel quality of each beam being maintained is poorer than the first threshold will the first node start to count, and, as soon as the counting meets a certain criterion the L1/L2 handover will be initiated.

According to one aspect of the present application, the action of demodulating a first signal comprises attempting to recover a first Medium Access Control (MAC) Protocol Data Unit (PDU), the first MAC PDU comprising the first identifier and the second identifier; only when the first MAC PDU is recovered will it be determined that a random access (RA) procedure to which the first characteristic sequence belongs is successful.

The present application provides a method in a second node for wireless communications, comprising:
receiving a first characteristic sequence and a target signal; and
transmitting a first signaling in a first time window; and transmitting a first signal;
herein, a channel occupied by the first characteristic sequence includes a random access (RA)-related channel, a transmission timing of the target signal is related to a transmission timing of the first characteristic sequence; the target signal comprises a first identifier, while the first signal comprises the first identifier and a second identifier, and Cyclic Redundancy Check (CRC) comprised in the first signaling is scrambled by a third identifier; the first signaling comprises configuration information of the first signal, the configuration information comprising a time-frequency resource set occupied by the first signal; the target signal is used to trigger the first signal; the first identifier is a Cell-Radio Network Temporary Identity (C-RNTI), the second identifier is a C-RNTI, and the third identifier is an RNTI different from the first identifier; the first time window is related to a time-domain resource occupied by the target signal.

According to one aspect of the present application, the first characteristic sequence and the target signal belong to a same message MSGA, with the third identifier being a MSGB-RNTI.

According to one aspect of the present application, comprising:
transmitting a third signal after the first characteristic sequence is received and before the target signal is received;
herein, the first characteristic sequence is used to trigger the third signal, the third signal indicating the third identifier.

According to one aspect of the present application, the first identifier is configured by a first cell, while the second identifier and third identifier are configured by a second cell, the first cell being different from the second cell; a first radio resource is used to determine a first reference signal resource, the first radio resource comprising at least one of a time-domain resource occupied by the first characteristic sequence, a frequency-domain resource occupied by the first characteristic sequence or a preamble index of the first characteristic sequence; or, the target signal comprises a first information element, the first information element in the target signal being used to indicate a first reference signal resource; the first reference signal resource is maintained by the second cell.

According to one aspect of the present application, comprising:
transmitting a first information block, the first information block being used to indicate M1 candidate reference signal resources; and
herein, the first reference signal resource is a candidate reference signal resource among the M1 candidate reference signal resources; a transmitter of the first information block is the first cell; M1 is a positive integer greater than 1.

According to one aspect of the present application, comprising:
transmitting a second information block, the second information block indicating a target reference signal resource group;
herein, a transmitter of the first characteristic sequence is a first node, the first node measuring the target reference signal resource group, where a channel quality of each reference signal resource in the target reference signal resource group is lower than a first threshold, and a first counter of the first node is incremented by 1; the target reference signal resource group comprises at least one reference signal resource, the first counter reaches a first trigger value, and the first characteristic sequence is triggered.

According to one aspect of the present application, comprising:
determining that the first identifier is occupied; and
transmitting a second signaling and a second signal in a second time window;
herein, CRC comprised in the second signaling is scrambled by the first identifier; the second signaling comprises configuration information of the second signal, the configuration information comprising a time-frequency resource set occupied by the second signal; the target signal is used to trigger the second signal.

The present application provides a first node for wireless communications, comprising:
a first transceiver, transmitting a first characteristic sequence and a target signal; and
a first receiver, monitoring a first signaling in a first time window; and when the first signaling is detected, demodulating a first signal;
herein, a channel occupied by the first characteristic sequence includes a random access (RA)-related channel, a transmission timing of the target signal is related to a transmission timing of the first characteristic sequence; the target signal comprises a first identifier, while the first signal comprises the first identifier and a second identifier, and Cyclic Redundancy Check (CRC) comprised in the first signaling is scrambled by a third identifier; the first signaling comprises configuration information of the first signal, the configuration information comprising a time-frequency resource set occupied by the first signal; the target signal is used to trigger the first signal; the first identifier is a Cell-Radio Network Temporary Identity (C-RNTI), the second identifier is a C-RNTI, and the third identifier is an RNTI different from the first identifier; the first time window is related to a time-domain resource occupied by the target signal.

The present application provides a second node for wireless communications, comprising:
a second transceiver, receiving a first characteristic sequence and a target signal; and
a first transmitter, transmitting a first signaling in a first time window; and transmitting a first signal;
herein, a channel occupied by the first characteristic sequence includes a random access (RA)-related channel, a transmission timing of the target signal is related to a transmission timing of the first characteristic sequence; the target signal comprises a first identifier, while the first signal comprises the first identifier and a second identifier, and Cyclic Redundancy Check (CRC) comprised in the first signaling is scrambled by a third identifier; the first signaling comprises configuration information of the first signal, the configuration information comprising a time-frequency resource set occupied by the first signal; the target signal is used to trigger the first signal; the first identifier is a Cell-Radio Network Temporary Identity (C-RNTI), the second identifier is a C-RNTI, and the third identifier is an RNTI different from the first identifier; the first time window is related to a time-domain resource occupied by the target signal.

In one embodiment, compared with the prior art, the present application is advantageous in the following aspects:
when the first node triggers a handover due to a BLF, in order to increase the speed of handover and avoid interaction with L3, the first node will directly initiate a random access to a target cell to which it is supposed to be switched, hence the avoidance of the triggering of measurement reporting and subsequent interactions between the current serving cell and the target cell, and an enhancement in handover efficiency and rate;
since the first node hasn’t established an RRC connection to a target cell, the first node will recommend a beam to the target cell by means of random access and, in the mean time, transmit to the target cell a C-RNTI already allocated to the first node in an original cell, that is, the first identifier; and then the target cell will send the C-RNTI allocated to the original cell via the first signal as feedback to the first node, which notifies the first node of the fact that the target signal is correctly received by the target cell;
when transmitting a C-RNTI assigned to an original cell the target cell also distributes a new C-RNTI assigned to the target cell, i.e., a second identifier to the first node, hence the completion of handover.

The present application provides a method in a first node for wireless communications, comprising:
transmitting a first message via an air interface, the first message comprising a first identity; and
monitoring a first signaling via an air interface in a first time window, the first signaling being identified by any identity in a first identity set;
when the first signaling is detected in the first time window, determining that a random access (RA) procedure to which the first message belongs is successful; when the first signaling is not detected in the first time window, determining that the RA procedure to which the first message belongs is unsuccessful;
herein, the first identity is a Cell-Radio Network Temporary Identifier (C-RNTI), the first identity set comprising multiple identities, and any identity in the first identity set being a Radio Network Temporary Identifier (RNTI); a time-domain resource occupied by the first message is used to determine the first time window.

In one embodiment, a technical feature of the above method lies in that: in order to increase the speed of handover and avoid L3 interaction, the first node will maintain its identity in multiple cells, namely, the first identity set is multiple RNTIs maintained by the first node in multiple cells, therefore, as the first node moves along these cells, any RNTI in the first identity set can be sent as a feedback for random access, which speeds up the random access to the terminal and improves the handover efficiency.

According to one aspect of the present application, when the first signaling is detected in the first time window, the second receiver receives a second message; the first signaling comprises configuration information of a channel occupied by the second message, the second message comprising the any identity in the first identity set.

In one embodiment, a technical feature of the above method lies in that: identities comprised in the first identity set are used for follow-up scheduling of the first node, which helps reduce the number of interactions and enhance the efficiency of handover.

According to one aspect of the present application, the action of monitoring a first signaling via an air interface in a first time window comprises: monitoring the first signaling respectively in a first Resource Element (RE) set and a second RE set in the first time window; the first identity is used for the monitoring action in the first RE set, while a second identity is used for the monitoring action in the second RE set, the first identity set comprising the first identity and the second identity.

In one embodiment, a technical feature of the above method lies in that: by making the first RE set and the second RE set correspond to different cells respectively, one is able to receive feedbacks for the first message on time-frequency resources corresponding to different cells, thus realizing a quicker handover.

According to one aspect of the present application, comprising:
transmitting a first characteristic sequence; and
receiving a third message;
herein, the first characteristic sequence is used to trigger the third message, the third message being used to trigger the first message.

According to one aspect of the present application, comprising:
receiving a first information block;
herein, the first information block is used to indicate a first identity set.

According to one aspect of the present application, the first identity and the second identity are respectively maintained by a first cell and a second cell, and an identifier corresponding to the first cell is different from that corresponding to the second cell.

According to one aspect of the present application, the first identity and the second identity are respectively assigned to the first node and a second terminal, where the first node and the second terminal are different terminals.

In one embodiment, a technical feature of the above method lies in that: if Groupcast is adopted in V2X, identities of multiple terminals can be shared between one another, thus the multiple identities can be used for response and scheduling of each terminal, hence an improvement in transmission efficiency.

According to one aspect of the present application, only when the first message is associated with downlink radio signal resources of a second cell can any identity comprised in the first identity set be used by the first node to determine whether the first signaling is correctly received.

In one embodiment, a technical feature of the above method lies in that: the first node determines, according to time-frequency resources or beam information associated with the first message being selected, whether it should initiate a random access to a source cell or to a new cell, and determines whether to detect the first signaling according to all identities in the first identity set or only according to the first identity, thus enhancing the efficiency of blind detection and avoiding erroneous detection.

The present application provides a method in a second node for wireless communications, comprising:
receiving a first message via an air interface, the first message comprising a first identity; and
transmitting a first signaling via an air interface in a first time window, the first signaling being identified by any identity in a first identity set;
herein, when the first signaling is detected in the first time window, a transmitter of the first message determines that a random access (RA) procedure to which the first message belongs is successful; when the first signaling is not detected in the first time window, a transmitter of the first message determines that the RA procedure to which the first message belongs is unsuccessful; the first identity is a C-RNTI, the first identity set comprising multiple identities, and any identity in the first identity set being an RNTI; a time-domain resource occupied by the first message is used to determine the first time window.

According to one aspect of the present application, comprising:
transmitting a second message;
herein, the first signaling comprises configuration information of a channel occupied by the second message, the second message comprising the any identity in the first identity set.

According to one aspect of the present application, the second node transmits the first signaling in at least one of a first RE set or a second RE set in the first time window; when the first signaling is transmitted in the first RE set, the first identity is used for scrambling CRC comprised in the first signaling; when the first signaling is transmitted in the second RE set, a second identity is used for scrambling CRC comprised in the first signaling; the first identity set comprises the first identity and the second identity.

According to one aspect of the present application, comprising:
receiving a first characteristic sequence; and
transmitting a third message;
herein, the first characteristic sequence is used to trigger the third message, the third message being used to trigger the first message.

According to one aspect of the present application, comprising:
transmitting a first information block;
herein, the first information block is used to indicate the first identity set.

According to one aspect of the present application, the first identity and the second identity are respectively maintained by a first cell and a second cell, and an identifier corresponding to the first cell is different from that corresponding to the second cell.

According to one aspect of the present application, the first identity and the second identity are respectively maintained by a first cell and a second cell, and an identifier corresponding to the first cell is different from that corresponding to the second cell.

According to one aspect of the present application, the first identity and the second identity are respectively assigned to the first node and a second terminal, where the first node and the second terminal are different terminals.

According to one aspect of the present application, only when the first message is associated with downlink radio signal resources of a second cell can any identity comprised in the first identity set be used by the second node for scrambling CRC comprised in the first signaling.

The present application provides a first node for wireless communications, comprising:
a first transceiver, transmitting a first message via an air interface, the first message comprising a first identity; and
a first receiver, monitoring a first signaling via an air interface in a first time window, the first signaling being identified by any identity in a first identity set; and
a second receiver, when the first signaling is detected in the first time window, determining that a random access (RA) procedure to which the first message belongs is successful; when the first signaling is not detected in the first time window, determining that the RA procedure to which the first message belongs is unsuccessful;
herein, the first identity is a C-RNTI, the first identity set comprising multiple identities, and any identity in the first identity set being an RNTI; a time-domain resource occupied by the first message is used to determine the first time window.

The present application provides a second node for wireless communications, comprising:
a second transceiver, receiving a first message via an air interface, the first message comprising a first identity; and
a first transmitter, transmitting a first signaling via an air interface in a first time window, the first signaling being identified by any identity in a first identity set;
herein, when the first signaling is detected in the first time window, a transmitter of the first message determines that a random access (RA) procedure to which the first message belongs is successful; when the first signaling is not detected in the first time window, a transmitter of the first message determines that the RA procedure to which the first message belongs is unsuccessful; the first identity is a C-RNTI, the first identity set comprising multiple identities, and any identity in the first identity set being an RNTI; a time-domain resource occupied by the first message is used to determine the first time window.

In one embodiment, compared with the prior art, the present application is advantageous in the following aspects:
in order to increase the speed of handover and avoid L3 interaction, the first node will maintain its identity in multiple cells, namely, the first identity set is multiple RNTIs maintained by the first node in multiple cells, therefore, as the first node moves along these cells, any RNTI in the first identity set can be sent as feedback for random access, which speeds up the random access to the terminal and improves the handover efficiency;
if Groupcast is adopted in V2X, identities of multiple terminals can be shared between one another, thus the multiple identities can be used for response and scheduling of each terminal, hence an improvement in transmission efficiency;
the first node determines, according to time-frequency resources or beam information associated with the first message being selected, whether it should initiate a random access to a source cell or to a new cell, and determines whether to detect the first signaling according to all identities in the first identity set or only according to the first identity, thus enhancing the efficiency of blind detection and avoiding erroneous detection.

### BRIEF DESCRIPTION OF THE DRAWINGS

Other features, objects and advantages of the present application will become more apparent from the detailed description of non-restrictive embodiments taken in conjunction with the following drawings:

FIG. 1A illustrates a flowchart of processing of a first node according to one embodiment of the present application.

FIG. 1B illustrates a flowchart of processing of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5A illustrates a flowchart of a first signal according to one embodiment of the present application.

FIG. 5B illustrates a flowchart of a first signaling according to one embodiment of the present application.

FIG. 6A illustrates a flowchart of a first signal according to another embodiment of the present application.

FIG. 6B illustrates a flowchart of a second message according to one embodiment of the present application.

FIG. 7A illustrates a flowchart of a first information block according to the present application.

FIG. 7B illustrates a flowchart of a first characteristic sequence according to one embodiment of the present application.

FIG. 8A illustrates a flowchart of a second information block according to the present application.

FIG. 8B illustrates a schematic diagram of a first RE set and a second RE set according to one embodiment of the present application.

FIG. 9A illustrates a flowchart of a second signaling according to the present application.

FIG. 9B illustrates a schematic diagram of a first cell and a second cell according to one embodiment of the present application.

FIG. 10A illustrates a schematic diagram of a first cell and a second cell according to one embodiment of the present application.

FIG. 10B illustrates a structure block diagram of a processing device in a first node according to one embodiment of the present application.

FIG. 11A illustrates a structure block diagram of a processing device in a first node according to one embodiment of the present application.

FIG. 11B illustrates a structure block diagram of a processing device in a second node according to one embodiment of the present application.

FIG. 12 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1A

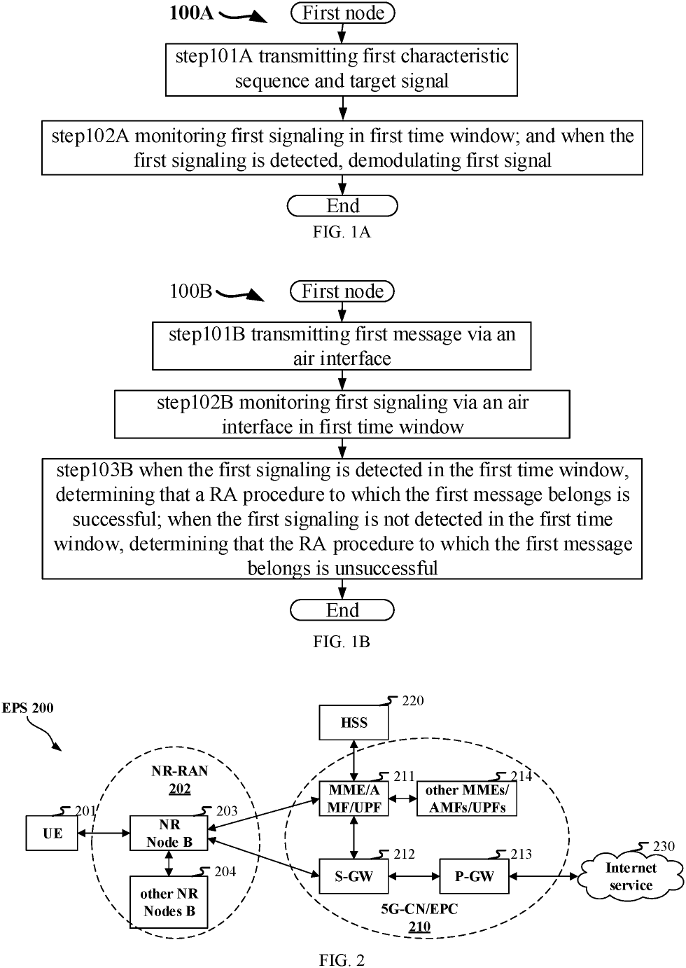

Embodiment 1A illustrates a flowchart of processing of a first node, as shown in FIG. 1A. In 100A illustrated by FIG. 1A, each box represents a step. In Embodiment 1A, the first node in the present application transmits a first characteristic sequence and a target signal in step 101A; and monitors a first signaling in a first time window in step 102A; and when the first signaling is detected, demodulates a first signal.

In Embodiment 1A, a channel occupied by the first characteristic sequence includes a random access (RA)-related channel, a transmission timing of the target signal is related to a transmission timing of the first characteristic sequence; the target signal comprises a first identifier, while the first signal comprises the first identifier and a second identifier, and Cyclic Redundancy Check (CRC) comprised in the first signaling is scrambled by a third identifier; the first signaling comprises configuration information of the first signal, the configuration information comprising a time-frequency resource set occupied by the first signal; the target signal is used to trigger the first signal; the first identifier is a Cell-Radio Network Temporary Identity (C-RNTI), the second identifier is a C-RNTI, and the third identifier is an RNTI different from the first identifier; the first time window is related to a time-domain resource occupied by the target signal.

In one embodiment, the first signal is a radio signal.

In one embodiment, the first signal is a baseband signal.

In one embodiment, the first characteristic sequence is a Preamble.

In one embodiment, the first characteristic sequence is an Msg1.

In one embodiment, a physical layer channel bearing the first characteristic sequence comprises a PRACH.

In one embodiment, the first characteristic sequence is used for a random access procedure.

In one embodiment, an MsgA comprises the first characteristic sequence.

In one embodiment, an MsgA comprises the target signal.

In one embodiment, a physical layer channel bearing the target signal comprises a Physical Uplink Shared Channel (PUSCH).

In one embodiment, the target signal comprises a Payload of an MsgA.

In one embodiment, the target signal comprises an Msg3.

In one embodiment, the target signal is used for a random access procedure.

In one embodiment, what bears the target signal is a Common Control Channel (CCCH).

In one embodiment, the first signaling is a piece of Downlink Control Information (DCI).

In one embodiment, a physical layer channel bearing the first signaling comprises a Physical Downlink Control Channel (PDCCH).

In one embodiment, the first signaling is used to indicate time-frequency resources occupied by the first signal.

In one embodiment, the first signaling is used for scheduling the first signal.

In one embodiment, a physical layer channel bearing the first signal comprises a PUSCH.

In one embodiment, the first signal is an Msg4.

In one embodiment, the first signal is a Contention Resolution.

In one embodiment, the first signal is an MsgB.

In one embodiment, the first signal is used for a random access procedure.

In one embodiment, the first signal comprises a MAC PDU.

In one embodiment, the first signal comprises a Contention Resolution Identity MAC Control Element of the first node.

In one embodiment, the first signal comprises a C-RNTI MAC Control Element (CE).

In one embodiment, the first time window lasts for T1 milliseconds (ms) in time domain, where T1 is a positive integer greater than 1.

In one embodiment, the first time window comprises a positive integer number of consecutive slots in time domain.

In one embodiment, the first time window is a msgB-ResponseWindow in TS 38.321.

In one embodiment, a duration of the first time window in time domain is equal to a ra-ContentionResolutionTimer in TS 38.321.

In one embodiment, the action of monitoring includes receiving.

In one embodiment, the action of monitoring includes Blind Decoding.

In one embodiment, the action of monitoring includes coherent detection.

In one embodiment, the action of monitoring includes energy detection.

In one embodiment, the action of monitoring includes determining according to CRC whether the first signaling is correctly received.

In one embodiment, the action of demodulating includes receiving.

In one embodiment, the action of demodulating includes channel estimation.

In one embodiment, the action of demodulating includes channel balancing.

In one embodiment, the action of demodulating includes channel decoding.

In one embodiment, when a first signaling is not detected in the first time window, drop receiving the first signal.

In one embodiment, when a first signaling is not detected in the first time window, retransmit the first characteristic sequence and the target signal.

In one embodiment, when a first signaling is not detected in the first time window, increment PREAMBLE-TRANSMISSION-COUNTER by 1.

In one embodiment, the phrase that a transmission timing of the target signal is related to a transmission timing of the first characteristic sequence includes a meaning that a transmission timing of the first characteristic sequence is used to determine a transmission timing of the target signal.

In one embodiment, the phrase that a transmission timing of the target signal is related to a transmission timing of the first characteristic sequence includes a meaning that a transmission timing of the first characteristic sequence and a transmission timing of the target signal are both based on a downlink synchronization timing.

In one embodiment, the phrase that a transmission timing of the target signal is related to a transmission timing of the first characteristic sequence includes a meaning that a transmission timing of the first characteristic sequence plus a Timing Advance is used to determine a slot synchronization timing, with a transmission timing of the target signal being based on the slot synchronization timing, and the Timing Advance being indicated by an RAR corresponding to the first characteristic sequence.

In one subembodiment, the transmission timing of the first characteristic sequence is based on a downlink synchronization.

In one embodiment, the phrase that a transmission timing of the target signal is related to a transmission timing of the first characteristic sequence includes a meaning that the first characteristic sequence and the target signal belong to a same Random Access Procedure.

In one embodiment, the first identifier is a non-negative integer.

In one embodiment, the first identifier is configured by the network before the first node transmits the first characteristic sequence.

In one embodiment, the first identifier is configured for the first node by a node other than a transmitter of the first signaling.

In one embodiment, the first identifier is configured for the first node by the third node in the present application.

In one embodiment, the second identifier is a non-negative integer.

In one embodiment, the second identifier is configured for the first node by a transmitter of the first signaling.

In one embodiment, the second identifier is configured for the first node by the second node in the present application.

In one embodiment, the third identifier is a non-negative integer.

In one embodiment, the third identifier is a Temporary C-RNTI (TC-RNTI).

In one embodiment, the third identifier is a MSGB-RNTI.

In one embodiment, the third identifier is linearly correlated with an index of a slot occupied by the first characteristic sequence.

In one embodiment, the third identifier is linearly correlated with an index of an Orthogonal Frequency Division Multiplexing (OFDM) symbol occupied by the first characteristic sequence.

In one embodiment, the third identifier is linearly correlated with a type of a carrier occupied by the first characteristic sequence.

In one embodiment, the phrase that the target signal is used to trigger the first signal includes a meaning that the target signal and the first signal belong to a same RA procedure.

In one embodiment, the phrase that the target signal is used to trigger the first signal includes a meaning that as a response to receiving the target signal, the first signal is transmitted.

In one embodiment, the phrase that the target signal is used to trigger the first signal includes a meaning that the target signal is used to trigger the first signaling.

In one embodiment, the phrase that the first time window is related to a time-domain resource occupied by the target signal includes a meaning that the first time window is after a slot occupied by the target signal.

In one embodiment, the phrase that the first time window is related to a time-domain resource occupied by the target signal includes a meaning that a slot occupied by the target signal is used to determine a first slot in the first time window.

In one embodiment, the phrase that the first time window is related to a time-domain resource occupied by the target signal includes a meaning that a slot occupied by the target signal is used to determine a first slot in the first time window.

In one embodiment, the phrase that the first time window is related to a time-domain resource occupied by the target signal includes a meaning that a first slot in the first time window is a L1-th slot after a slot occupied by the target signal, L1 being a positive integer.

In one subembodiment, L1 is 1.

In one subembodiment, L1 is configured via a higher layer signaling.

In one embodiment, a number of slots comprised in the first time window is unrelated to the time-domain resource occupied by the target signal.

In one embodiment, a number of slots comprised in the first time window is configured via a higher layer signaling.

In one embodiment, the RA-related channel is a Physical Random Access Channel (PRACH).

In one embodiment, the RA-related channel includes a Random Access Channel (RACH).

In one embodiment, a transmission of the first characteristic sequence is Contention Based.

In one embodiment, a transmission of the first characteristic sequence is Contention Free.

In one embodiment, the transmission timing comprises synchronization of a radio frame.

In one embodiment, the transmission timing comprises determination of a start time.

In one embodiment, the transmission timing comprises synchronization of a sub-frame.

In one embodiment, the transmission timing comprises synchronization of a slot.

In one embodiment, the transmission timing comprises synchronization of an OFDM symbol.

In one embodiment, the first characteristic sequence and the target signal belong to an MsgA, while the first signal belongs to an MsgB.

In one embodiment, the first characteristic sequence occupies a first time-frequency resource set, the first time-frequency resource set belonging to a first time-frequency resource pool, the first time-frequency resource pool only being used for a PRACH transmission resulting from mobility.

In one subembodiment, the PRACH transmission resulting from mobility comprises a PRACH transmission resulting from a Beamlink Failure (BLF).

In one subembodiment, the PRACH transmission resulting from mobility comprises a PRACH transmission resulting from a triggering of L1/L2 inter-cell handover.

In one subembodiment, the first time-frequency resource pool is specific to a terminal group, where each terminal in the terminal group supports L1 or L2 inter-cell handover.

In one embodiment, the first characteristic sequence is only used for generating a PRACH triggered by L1 or L2 inter-cell handover being triggered.

In one embodiment, the target signal comprises a second information element, the second information element being used to determine that a serving cell of the first node is not a cell where the second node in the present application is located.

In one embodiment, the second information element indicates a Physical Cell Identity (PCI) of a serving cell of the first node.

In one subembodiment, the second information element is used to indicate that the first characteristic sequence is triggered by L1/L2 inter-cell handover.

### Embodiment 1B

Embodiment 1B illustrates a flowchart of processing of a first node, as shown in FIG. 1B. In 100B illustrated by FIG. 1B, each box represents a step. In Embodiment 1B, the first node in the present application transmits a first message via an air interface in step 101B; monitors a first signaling via an air interface in a first time window in step 102B; and in step 103B, when the first signaling is detected in the first time window, determines that a random access (RA) procedure to which the first message belongs is successful; when the first signaling is not detected in the first time window, determines that the RA procedure to which the first message belongs is unsuccessful.

In Embodiment 1B, the first message comprises a first identity, the first signaling being identified by any identity in a first identity set; the first identity is a C-RNTI, the first identity set comprising multiple identities, and any identity in the first identity set being an RNTI; a time-domain resource occupied by the first message is used to determine the first time window.

In one embodiment, the meaning of being via an air interface comprises: being transmitted via a radio signal.

In one embodiment, the meaning of being via an air interface comprises: being transmitted via a cellular link.

In one embodiment, the meaning of being via an air interface comprises: being transmitted via sidelink.

In one embodiment, the meaning of being via an air interface comprises: the first message being transmitted via a radio signal.

In one embodiment, the meaning of being via an air interface comprises: a receiver of the first message and the first node being Non-Quasi Co-located.

In one embodiment, the meaning of being via an air interface comprises: there being no wired connection between a receiver of the first message and the first node.

In one embodiment, the air interface includes a PC-5 interface.

In one embodiment, the air interface includes a Uu interface.

In one embodiment, the monitoring includes blind detection.

In one embodiment, the monitoring includes Cyclic Redundancy Check (CRC).

In one embodiment, the monitoring includes reception.

In one embodiment, the monitoring includes demodulation.

In one embodiment, the monitoring includes coherent detection.

In one embodiment, the monitoring includes energy detection.

In one embodiment, the first message is used to trigger the first signaling.

In one embodiment, a physical layer channel bearing the first message includes a Physical Uplink Shared Channel (PUSCH).

In one embodiment, a physical layer channel bearing the first message includes a Physical Random Access Channel (PRACH).

In one embodiment, the above-mentioned phrase that the first message comprises a first identity means that: the first message indicates the first identity.

In one embodiment, the above-mentioned phrase that the first message comprises a first identity means that: the first identity is used for generating a radio signal carrying the first message.

In one embodiment, the above-mentioned phrase that the first message comprises a first identity means that: the first identity is used for generating a Preamble carrying the first message.

In one embodiment, the above-mentioned phrase that the first message comprises a first identity means that: the first identity is used for generating a sequence carrying the first message.

In one embodiment, the above-mentioned phrase that the first message comprises a first identity means that: a radio resource occupied by the first message is used to indicate the first identity, the radio resource comprising at least one of a frequency-domain resource, a time-domain resource or a code-domain resource.

In one embodiment, the first message is an Msg1.

In one embodiment, the first message is an Msg3.

In one embodiment, the first message is an MsgA.

In one embodiment, the first message comprises C-RNTI Medium Access Control (MAC) Control Elements (CE).

In one embodiment, the first message comprises a UE Contention Resolution Identity MAC CE.

In one embodiment, the first time window is a ra-ContentionResolutionTimer.

In one embodiment, a start of the first time window is a start time of a ra-ContentionResolutionTimer, and an end of the first time window is an expiration time of a ra-ContentionResolutionTimer.

In one embodiment, a start of the first time window is a start time of a ra-ContentionResolutionTimer, and an end of the first time window is a time of a ra-ContentionResolutionTimer being stopped.

In one embodiment, a start of the first time window is a start time of a msgB-ResponseWindow.

In one embodiment, an end of the first time window is an expiration time of a msgB-ResponseWindow.

In one embodiment, an end of the first time window is a time of a msgB-ResponseWindow being stopped.

In one embodiment, the first identity is a non-negative integer.

In one embodiment, the first identity is an Identity.

In one embodiment, the first identity is expressed in a 4-digit hexadecimal number.

In one embodiment, the first identity is used for identifying the first node.

In one embodiment, the first identity is used for uniquely identifying the first node in a cell.

In one embodiment, the first identity is used for uniquely identifying the first node in a terminal group.

In one embodiment, the first identity set comprises the first identity.

In one embodiment, the first identity set does not comprise the first identity.

In one embodiment, the first identity set comprises K1 identities, K1 being a positive integer greater than 1.

In one subembodiment, any identity among the K1 identities is a C-RNTI.

In one subembodiment, any identity among the K1 identities is an RNTI.

In one subembodiment, any identity among the K1 identities is a Member ID.

In one subembodiment, any identity among the K1 identities is a Destination ID.

In one subembodiment, the K1 identities are identities of the first node in K1 cells, respectively.

In one subembodiment, the K1 identities are identities of the first node in K1 base stations, respectively.

In one subembodiment, the K1 identities are identities of the first node in K1 TRPs, respectively.

In one subembodiment, the K1 identities respectively correspond to K1 different terminals, the first node is one of the K1 terminals, and the K1 different terminals belong to a terminal group.

In one embodiment, the first identity set only comprises the first identity and the second identity in the present application.

In one embodiment, the action of determining that the RA procedure to which the first message belongs is unsuccessful comprises: re-initiating a new RA procedure.

In one embodiment, the action of determining that the RA procedure to which the first message belongs is unsuccessful comprises: incrementing a first counter by 1.

In one subembodiment, the first counter is maintained in a MAC layer.

In one subembodiment, the first counter is a PREAMBLE _TRANSMISSION _COUNTER.

In one subembodiment, when the first counter reaches a first threshold, a higher layer is notified of an issue of random access.

In one subembodiment, when the first counter reaches a first threshold, it is determined that Radio Link Failure (RLF) occurs.

In one subembodiment, the first threshold in the present application is equal to a sum of preambleTransMax and 1.

In one embodiment, the RA is used for an access to a base station initiated by the first node.

In one embodiment, the RA is used for an access to a terminal initiated by the first node.

In one embodiment, the RA is used for an access to a Road Side Unit (RSU) initiated by the first node.

In one embodiment, the RA is used for an access to a Group Head initiated by the first node.

In one embodiment, when the first signaling is identified by a given identity, CRC comprised in the first signaling is scrambled by the given identity.

In one embodiment, when the first signaling is identified by a given identity, the given identity is used for generating an RS sequence of Demodulation Reference Signal(s) (DMRS) of a channel occupied by the first signaling.

In one embodiment, when the first signaling is identified by a given identity, the first signaling indicates the given identity.

In one embodiment, when the first signaling is identified by a given identity, a data channel scheduled by the first signaling indicates the given identity.

In one embodiment, when the first signaling is identified by a given identity, the given identity is used to determine a Resource Element (RE) set occupied by the first signaling.

In one embodiment, when the first signaling is identified by a given identity, the given identity is used to determine a Control Resource Set (CORESET) to which the first signaling belongs.

In one embodiment, when the first signaling is identified by a given identity, the given identity is used to determine a Search Space Set to which the first signaling belongs.

In one embodiment, when the first signaling is identified by a given identity, the given identity is used to determine a CORESET Pool to which the first signaling belongs.

In one embodiment, when the first signaling is identified by a given identity, the given identity is used to determine a Search Space Set Pool to which the first signaling belongs.

In one embodiment, the given identity in the present application is any identity in the first identity set.

In one embodiment, the given identity in the present application is an identity in the first identity set.

In one embodiment, a physical layer channel occupied by the first signaling includes a Physical Downlink Control Channel (PDCCH).

In one embodiment, a physical layer signaling occupied by the first signaling includes a Physical Sidelink Control Channel (PSCCH).

In one embodiment, the sentence that a time-domain resource occupied by the first message is used to determine the first time window includes a meaning that slot(s) occupied by the first message is(are) used to determine a starting slot occupied by the first time window in time domain.

In one embodiment, the sentence that a time-domain resource occupied by the first message is used to determine the first time window includes a meaning that slot(s) occupied by the first message is(are) used to determine an ending slot occupied by the first time window in time domain.

In one embodiment, the sentence that a time-domain resource occupied by the first message is used to determine the first time window includes a meaning that the first message occupies an N-th slot, and a starting slot occupied by the first time window is a (N+N1)-th slot, where N1 is fixed, or N1 is configured through an RRC signaling; N and N1 are both non-negative integers.

In one embodiment, the first time window occupies a positive integer number of consecutive milliseconds (ms) in time domain.

In one embodiment, the first time window occupies a positive integer number of consecutive slots in time domain.

In one embodiment, the first identity and the second identity are respectively used for data transmissions on a first radio bearer and a second radio bearer.

In one subembodiment, a Radio Link Control (RLC) bearer in the first radio bearer and an RLC bearer in the second radio bearer are respectively configured by two different CellGroupConfig IEs.

In one embodiment, the first signaling is a piece of Downlink Control Information (DCI).

In one embodiment, the first signaling is a piece of Sidelink Control Information (SCI).

### Embodiment 2

Embodiment 2 illustrates a schematic diagram of a network architecture, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called an Evolved Packet System (EPS) 200 or other suitable terminology. The EPS 200 may comprise one UE 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/ Authentication Management Field (AMF)/ User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 is a terminal capable of triggering L1/L2 inter-cell handover.

In one embodiment, the UE 201 is a terminal capable of monitoring multiple beams simultaneously.

In one embodiment, the UE 201 is a terminal supporting Massive-MIMO.

In one embodiment, the gNB203 corresponds to the second node in the present application.

In one embodiment, the gNB203 supports the functionality of L1/L2 inter-cell handover.

In one embodiment, the gNB203 supports multi-beam transmission.

In one embodiment, the UE201 supports Massive-MIMO-based transmission.

### Embodiment 3

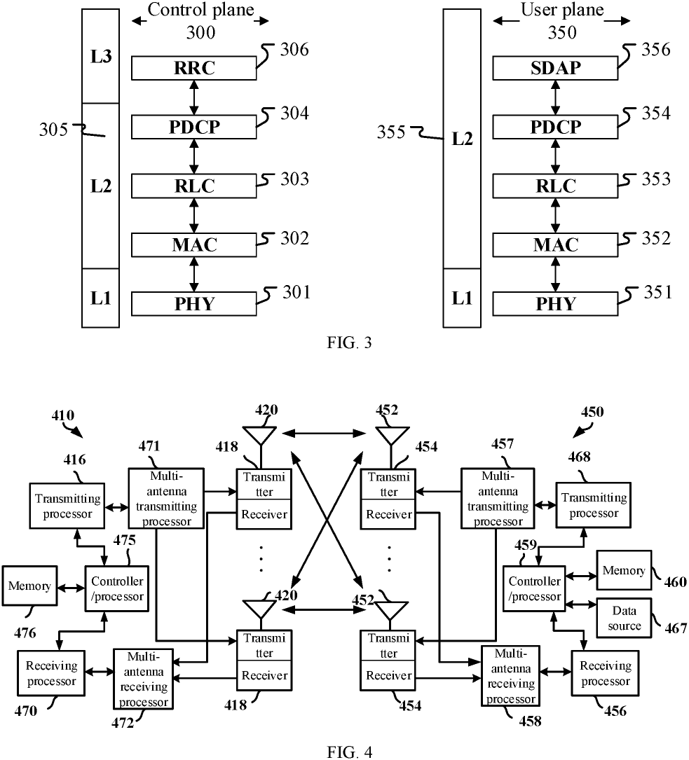

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between the first communication node and the second communication node via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication nodes of the network side. The PDCP sublayer 304 provides multiplexing among variable radio bearers and logical channels. The PDCP sublayer 304 provides security by encrypting a packet and also provides support for handover of a second communication node between first communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The Radio Resource Control (RRC) sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the radio protocol architecture in FIG. 3 is applicable to the third node in the present application.

In one embodiment, the PDCP304 of the second communication node is used for generating scheduling of the first communication node.

In one embodiment, the PDCP354 of the second communication node is used for generating scheduling of the first communication node.

In one embodiment, the first characteristic sequence in the present application is generated by the PHY301 or the PHY351.

In one embodiment, the first characteristic sequence in the present application is generated by the MAC302 or the MAC352.

In one embodiment, the target signal in the present application is generated by the PHY301 or the PHY351.

In one embodiment, the target signal in the present application is generated by the MAC302 or the MAC352.

In one embodiment, the target signal in the present application is generated by the RRC306.

In one embodiment, the first signaling in the present application is generated by the PHY301 or the PHY351.

In one embodiment, the first signaling in the present application is generated by the MAC302 or the MAC352.

In one embodiment, the first signal in the present application is generated by the MAC302 or the MAC352.

In one embodiment, the first signal in the present application is generated by the RRC306.

In one embodiment, the third signal in the present application is generated by the PHY301 or the PHY351.

In one embodiment, the third signal in the present application is generated by the MAC302 or the MAC352.

In one embodiment, the third signal in the present application is generated by the RRC306.

In one embodiment, the first information block in the present application is generated by the RRC306.

In one embodiment, the second information block in the present application is generated by the RRC306.

In one embodiment, the second signaling in the present application is generated by the PHY301 or the PHY351.

In one embodiment, the second signaling in the present application is generated by the MAC302 or the MAC352.

In one embodiment, the second signal in the present application is generated by the PHY301 or the PHY351.

In one embodiment, the second signal in the present application is generated by the MAC302 or the MAC352.

In one embodiment, the second signal in the present application is generated by the RRC306.

In one embodiment, the first node is a terminal.

In one embodiment, the second node is a terminal.

In one embodiment, the second node is a Transmitter Receiver Point (TRP).

### Embodiment 4

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of HARQ operation, a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts baseband multicarrier symbol streams which have gone through reception analog precoding/beamforming operations from time domain to frequency domain using FFT. In frequency domain, physical layer data signals and reference signals are de-multiplexed by the receiving processor 456, where the reference signals are used for channel estimation while data signals are processed in the multi-antenna receiving processor 458 by multi-antenna detection to recover any spatial stream targeting the first communication device 450. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory, the at least one memory comprises computer program codes; the at least one memory and the computer program codes are configured to be used in collaboration with the at least one processor. The first communication device 450 at least: transmits a first characteristic sequence and a target signal; and monitors a first signaling in a first time window; and when the first signaling is detected, demodulates a first signal; a channel occupied by the first characteristic sequence includes a random access (RA)-related channel, a transmission timing of the target signal is related to a transmission timing of the first characteristic sequence; the target signal comprises a first identifier, while the first signal comprises the first identifier and a second identifier, and Cyclic Redundancy Check (CRC) comprised in the first signaling is scrambled by a third identifier; the first signaling comprises configuration information of the first signal, the configuration information comprising a time-frequency resource set occupied by the first signal; the target signal is used to trigger the first signal; the first identifier is a Cell-Radio Network Temporary Identity (C-RNTI), the second identifier is a C-RNTI, and the third identifier is an RNTI different from the first identifier; the first time window is related to a time-domain resource occupied by the target signal.

In one embodiment, the first communication node 450 comprises a memory that stores a computer readable instruction program, the computer readable instruction program generates actions when executed by at least one processor, which include: transmitting a first characteristic sequence and a target signal; and monitoring a first signaling in a first time window; and when the first signaling is detected, demodulating a first signal; a channel occupied by the first characteristic sequence includes a random access (RA)-related channel, a transmission timing of the target signal is related to a transmission timing of the first characteristic sequence; the target signal comprises a first identifier, while the first signal comprises the first identifier and a second identifier, and Cyclic Redundancy Check (CRC) comprised in the first signaling is scrambled by a third identifier; the first signaling comprises configuration information of the first signal, the configuration information comprising a time-frequency resource set occupied by the first signal; the target signal is used to trigger the first signal; the first identifier is a Cell-Radio Network Temporary Identity (C-RNTI), the second identifier is a C-RNTI, and the third identifier is an RNTI different from the first identifier; the first time window is related to a time-domain resource occupied by the target signal.

In one embodiment, the second communication device 410 comprises at least one processor and at least one memory, the at least one memory comprises computer program codes; the at least one memory and the computer program codes are configured to be used in collaboration with the at least one processor. The second communication device 410 at least: receives a first characteristic sequence and a target signal; and transmits a first signaling in a first time window; and transmits a first signal; a channel occupied by the first characteristic sequence includes a random access (RA)-related channel, a transmission timing of the target signal is related to a transmission timing of the first characteristic sequence; the target signal comprises a first identifier, while the first signal comprises the first identifier and a second identifier, and Cyclic Redundancy Check (CRC) comprised in the first signaling is scrambled by a third identifier; the first signaling comprises configuration information of the first signal, the configuration information comprising a time-frequency resource set occupied by the first signal; the target signal is used to trigger the first signal; the first identifier is a Cell-Radio Network Temporary Identity (C-RNTI), the second identifier is a C-RNTI, and the third identifier is an RNTI different from the first identifier; the first time window is related to a time-domain resource occupied by the target signal.

In one embodiment, the second communication device 410 comprises a memory that stores a computer readable instruction program, the computer readable instruction program generates actions when executed by at least one processor, which include: receiving a first characteristic sequence and a target signal; and transmitting a first signaling in a first time window; and transmitting a first signal; a channel occupied by the first characteristic sequence includes a random access (RA)-related channel, a transmission timing of the target signal is related to a transmission timing of the first characteristic sequence; the target signal comprises a first identifier, while the first signal comprises the first identifier and a second identifier, and Cyclic Redundancy Check (CRC) comprised in the first signaling is scrambled by a third identifier; the first signaling comprises configuration information of the first signal, the configuration information comprising a time-frequency resource set occupied by the first signal; the target signal is used to trigger the first signal; the first identifier is a Cell-Radio Network Temporary Identity (C-RNTI), the second identifier is a C-RNTI, and the third identifier is an RNTI different from the first identifier; the first time window is related to a time-domain resource occupied by the target signal.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a terminal.

In one embodiment, the second communication device 410 is a base station.

In one embodiment, the second communication device 410 is network equipment.

In one embodiment, the second communication device 410 is a serving cell.

In one embodiment, the second communication device 410 is a TRP.

In one embodiment, at least the first four of the antenna 452, the transmitter 454, the multi-antenna transmitting processor 457, the transmitting processor 468 or the controller/processor 459 are used for transmitting a first characteristic sequence and a target signal; at least the first four of the antenna 420, the receiver 418, the multi-antenna receiving processor 472, the receiving processor 470 or the controller/processor 475 are used for receiving a first characteristic sequence and a target signal.

In one embodiment, at least the first four of the antenna 452, the receiver 454, the multi-antenna receiving processor 458, the receiving processor 456, and the controller/processor 459 are used for monitoring a first signaling in a first time window; and when the first signaling is detected, demodulating a first signal; at least the first four of the antenna 420, the transmitter 418, the multi-antenna transmitting processor 471, the transmitting processor 416 and the controller/processor 475 are used for transmitting a first signaling in a first time window; and transmitting a first signal.

In one embodiment, at least the first four of the antenna 452, the receiver 454, the multi-antenna receiving processor 458, the receiving processor 456, and the controller/processor 459 are used for receiving a third signal; and when the first signaling is detected, demodulating a first signal; at least the first four of the antenna 420, the transmitter 418, the multi-antenna transmitting processor 471, the transmitting processor 416 and the controller/processor 475 are used for transmitting a third signal in a first time window.

In one embodiment, at least the first four of the antenna 452, the receiver 454, the multi-antenna receiving processor 458, the receiving processor 456, and the controller/processor 459 are used for receiving a first information block; at least the first four of the antenna 420, the transmitter 418, the multi-antenna transmitting processor 471, the transmitting processor 416 and the controller/processor 475 are used for transmitting a first information block.

In one embodiment, at least the first four of the antenna 452, the receiver 454, the multi-antenna receiving processor 458, the receiving processor 456, and the controller/processor 459 are used for selecting the first reference signal resource from the M1 candidate reference signal resources.

In one embodiment, at least the first four of the antenna 452, the transmitter 454, the multi-antenna transmitting processor 457, the transmitting processor 468, and the controller/processor 459 are used for selecting the first reference signal resource from the M1 candidate reference signal resources.

In one embodiment, at least the first four of the antenna 452, the receiver 454, the multi-antenna receiving processor 458, the receiving processor 456, and the controller/processor 459 are used for receiving a second information block; at least the first four of the antenna 420, the transmitter 418, the multi-antenna transmitting processor 471, the transmitting processor 416 and the controller/processor 475 are used for transmitting a second information block.

In one embodiment, at least the first four of the antenna 452, the receiver 454, the multi-antenna receiving processor 458, the receiving processor 456, and the controller/processor 459 are used for measuring a target reference signal resource group; at least the first four of the antenna 420, the transmitter 418, the multi-antenna transmitting processor 471, the transmitting processor 416 and the controller/processor 475 are used for transmitting a first-type reference signal in the target reference signal resource group.

In one embodiment, at least the first four of the antenna 420, the receiver 418, the multi-antenna receiving processor 472, the receiving processor 470 and the controller/processor 475 are used for determining that the first identifier is occupied.

In one embodiment, at least the first four of the antenna 420, the transmitter 418, the multi-antenna transmitting processor 471, the transmitting processor 416 and the controller/processor 475 are used for transmitting a second signaling and a second signal in a second time window.

### Embodiment 5A

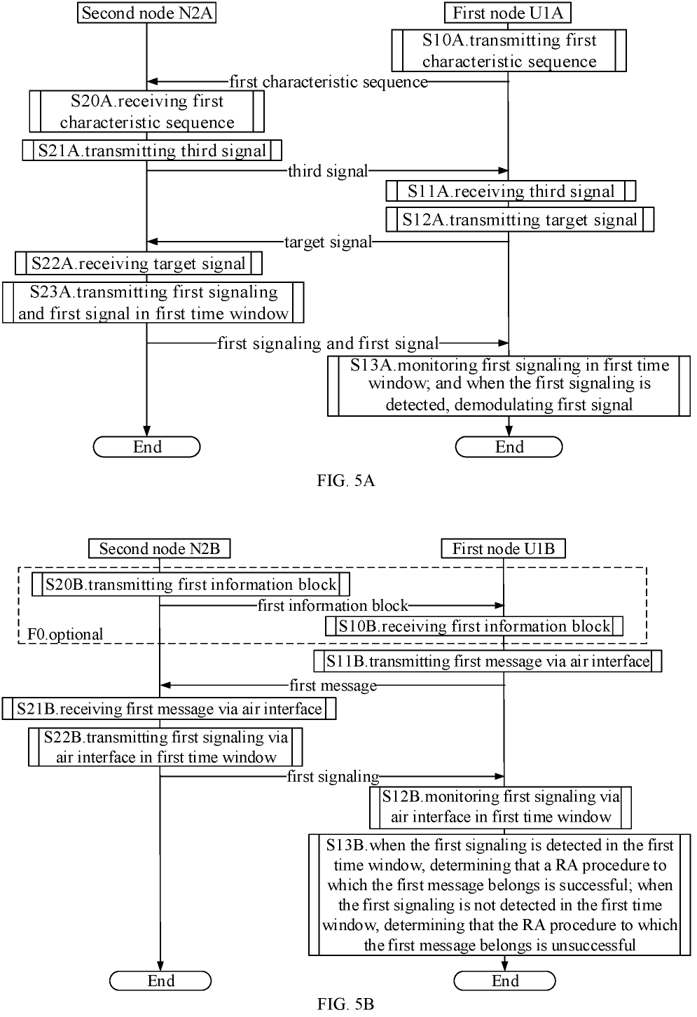

Embodiment 5A illustrates a flowchart of a first signal, as shown in FIG. 5A. In FIG. 5A, a first node U1A and a second node N2A are in communication via a radio link. It should be particularly noted that the sequence illustrated herein does not set any limit to the signal transmission order or implementation order in the present application. In case of no conflict, the embodiments, the subsidiary subembodiments and subsidiary embodiments provided in Embodiment 5A can be applied also in Embodiment 6A, Embodiment 7A and Embodiment 8A and Embodiment 9A.

The first node U1A transmits a first characteristic sequence in step S10A; receives a third signal in step S11A; and transmits a target signal in step S12A; and in step S13A, monitors a first signaling in a first time window, and when the first signaling is detected, demodulates a first signal.

The second node N2A receives a first characteristic sequence in step S20A; transmits a third signal in step S21A; receives a target signal in step S22A; and transmits a first signaling and a first signal in a first time window in step S23A.

In Embodiment 5A, a channel occupied by the first characteristic sequence includes a random access (RA)-related channel, a transmission timing of the target signal is related to a transmission timing of the first characteristic sequence; the target signal comprises a first identifier, while the first signal comprises the first identifier and a second identifier, and Cyclic Redundancy Check (CRC) comprised in the first signaling is scrambled by a third identifier; the first signaling comprises configuration information of the first signal, the configuration information comprising a time-frequency resource set occupied by the first signal; the target signal is used to trigger the first signal; the first identifier is a Cell-Radio Network Temporary Identity (C-RNTI), the second identifier is a C-RNTI, and the third identifier is an RNTI different from the first identifier; the first time window is related to a time-domain resource occupied by the target signal; the first characteristic sequence is used to trigger the third signal, the third signal indicating the third identifier.

In one embodiment, the first node U1A receives a third signal after the first characteristic sequence is transmitted and before the target signal is transmitted.

In one embodiment, the second node N2A transmits a third signal after the first characteristic sequence is received and before the target signal is received.

In one embodiment, the third signal is an Msg2.

In one embodiment, the third signal comprises an RAR.

In one embodiment, the third signal comprises an RAR in response to the first characteristic sequence, the third identifier being TEMPORARY_C-RNTI.

In one embodiment, the first characteristic sequence, the third signal, the target signal and the first signal respectively comprise an Msg1, an Msg2, an Msg3 and an Msg4.

In one embodiment, a start of the first time window is a start time of a ra-ContentionResolutionTimer, and an end of the first time window is an expiration time of a ra-ContentionResolutionTimer.

In one embodiment, a start of the first time window is a start time of a ra-ContentionResolutionTimer, and an end of the first time window is a time of a ra-ContentionResolutionTimer being stopped.

In one embodiment, the first identifier is configured by a first cell, while the second identifier and third identifier are configured by a second cell, the first cell being different from the second cell; a first radio resource is used to determine a first reference signal resource, the first radio resource comprising at least one of a time-domain resource occupied by the first characteristic sequence, a frequency-domain resource occupied by the first characteristic sequence or a preamble index of the first characteristic sequence; or, the target signal comprises a first information element, the first information element in the target signal being used to indicate a first reference signal resource; the first reference signal resource is maintained by the second cell.

In one subembodiment, the second cell is attached to the second node N2.

In one subembodiment, the first cell is not attached to the second node N2.

In one subembodiment, the second cell is the second node N2.

In one subembodiment, the first cell is not the second node N2.

In one subembodiment, the second cell and the first cell are attached to the second node N2.

In one subembodiment, the first cell is a Cell.

In one subembodiment, the second cell is a Cell.

In one subembodiment, the first cell is a Serving Cell.

In one subembodiment, the second cell is a Serving Cell.

In one subembodiment, a PCID used by the first cell is different from a PCI used by the second cell.

In one subembodiment, the first cell is a currently camped cell of the first node.

In one embodiment, the second cell is a target cell as the first node starts an Intercell Layer 1 handover.

In one embodiment, the second cell is a target cell as the first node starts an Intercell Layer 1 handover.

In one subembodiment, the first node has established an RRC connection to the first cell, and the first node hasn’t yet established any RRC connection to the second cell.

In one subembodiment, the first radio resource comprises a time-frequency PRACH occasion occupied by the first characteristic sequence and a Preamble Index of the first characteristic sequence.

In one subembodiment, the phrase that the first reference signal resource is maintained by the second cell comprises that: reference signal(s) in the first reference signal resource is(are) transmitted by the second cell.

In one subembodiment, the first reference signal resource comprises a Synchronization Signal Block (SSB).

In one subembodiment, a cell identity of the second cell is used for generating an SSB comprised in the first reference signal resource.

In one subembodiment, the first reference signal resource comprises a Channel State Information-Reference Signal (CSI-RS).

In one subembodiment, the first reference signal resource comprises a Synchronisation Signal/physical broadcast channel Block (SSB).

In one subembodiment, the first reference signal resource comprises a CSI-RS resource.

In one subembodiment, the first reference signal resource comprises an SSB resource.

In one subembodiment, the first reference signal resource corresponds to a CSI-RS Resource Identity.

In one subembodiment, the first reference signal resource corresponds to a CSI-RS Resource Set Identity.

In one subembodiment, the first reference signal resource corresponds to an SSB Index.

In one subembodiment, the first reference signal resource corresponds to a Control Resource SeT (CORESET) Identity.

In one subembodiment, the first reference signal resource corresponds to a CORESET pool identity.

In one subembodiment, the first reference signal resource corresponds to a Search Space Set Identity.

In one subembodiment, the first reference signal resource corresponds to a search space set pool identity.

In one subembodiment, the first information element is a MAC CE.

In one subembodiment, the first information element is a Beam Failure Recovery (BFR) MAC CE.

In one subembodiment, the phrase that the first reference signal resource is maintained by the second cell means that: a configuration parameter of the first reference signal resource is configured by a higher layer signaling transmitted by the second cell, where the configuration parameter of the first reference signal resource includes at least one of two parameters generating occupied Resource Elements (REs) and a Reference Signal (RS) sequence.

In one subsidiary embodiment of the above subembodiment, the higher layer signaling transmitted by the second cell comprises an NZP-CSI-RS-Resource Information Element (IE).

In one subsidiary embodiment of the above subembodiment, the higher layer signaling transmitted by the second cell comprises a ZP-CSI-RS-Resource IE.

In one subsidiary embodiment of the above subembodiment, the higher layer signaling transmitted by the second cell comprises a CSI-IM-Resource IE.

In one subsidiary embodiment of the above subembodiment, the higher layer signaling transmitted by the second cell comprises an SSB.

In one subsidiary embodiment of the above subembodiment, the higher layer signaling transmitted by the second cell comprises a PDCCH-ConfigCommon IE.

In one subsidiary embodiment of the above subembodiment, the higher layer signaling transmitted by the second cell comprises a BWP-DownlinkCommon IE.

In one subsidiary embodiment of the above subembodiment, the higher layer signaling transmitted by the second cell comprises a CORESET IE.

In one subembodiment, a receiver of the first characteristic sequence and the target signal is the second cell, and a transmitter of the first signaling and the first signal is the second cell.

In one subembodiment, a transmitter of the third signal is the second cell.

In one embodiment, the action of demodulating a first signal comprises attempting to recover a first MAC Protocol Data Unit (PDU), the first MAC PDU comprising the first identifier and the second identifier; only when the first MAC PDU is recovered will it be determined that a random access (RA) procedure to which the first characteristic sequence belongs is successful.

In one subembodiment, in the case when failing to recover the first MAC PDU according to a radio signal received in the first time window, the first node U1 A determines that the RA procedure to which the first characteristic sequence belongs is failed.

In one subembodiment, when a first signaling is detected and the first MAC PDU fails to be recovered, the first node U1 A cannot determine whether the RA procedure to which the first characteristic sequence belongs is successful.

### Embodiment 5B

Embodiment 5B illustrates a flowchart of a first signaling, as shown in FIG. 5B. In FIG. 5B, a first node U1B and a second node N2B are in communication via a radio link. It should be particularly noted that the sequence illustrated herein does not set any limit to the signal transmission order or implementation order in the present application. In case of no conflict, the embodiments, the subsidiary subembodiments and subsidiary embodiments provided in Embodiment 5B can be applied also in Embodiment 6B and Embodiment 7B. In FIG. 5b, steps marked by the box F0 are optional.

The first node U1B receives a first information block in step S10B; and transmits a first message via an air interface in step S11B; monitors a first signaling via an air interface in a first time window in step 12B; and in step 13B, when the first signaling is detected in the first time window, determines that a random access (RA) procedure to which the first message belongs is successful; when the first signaling is not detected in the first time window, determines that the RA procedure to which the first message belongs is unsuccessful.

The second node N2B transmits a first information block in step S20B; and receives a first message via an air interface in step S21B; and transmits a first signaling via an air interface in a first time window in step S22B.

In Embodiment 5B, the first message comprises a first identity, the first signaling being identified by any identity in a first identity set; the first identity is a C-RNTI, the first identity set comprising multiple identities, and any identity in the first identity set being an RNTI; a time-domain resource occupied by the first message is used to determine the first time window; the first information block is used to indicate a first identity set.

In one embodiment, the action of monitoring a first signaling via an air interface in a first time window comprises: monitoring the first signaling respectively in a first RE set and a second RE set in the first time window; the first identity is used for the monitoring action in the first RE set, while a second identity is used for the monitoring action in the second RE set, the first identity set comprising the first identity and the second identity.

In one subembodiment, the first RE set comprises a Control Resource Set (CORESET).

In one subembodiment, the second RE set comprises a CORESET.

In one subembodiment, the first RE set comprises a CORESET pool.

In one subembodiment, the second RE set comprises a CORESET pool.

In one subembodiment, the first RE set and the second RE set belong to a same CORESET pool.

In one subembodiment, the first RE set comprises a search space set.

In one subembodiment, the second RE set comprises a search space set.

In one subembodiment, the first RE set comprises a search space set pool.

In one subembodiment, the second RE set comprises a search space set pool.

In one subembodiment, the first RE set and the second RE set belong to a same search space set pool.

In one subembodiment, the first node U1B uses a first spatial Rx parameter in the first RE set for monitoring, and the first node U1B uses a second spatial Rx parameter in the second RE set for monitoring, where the first spatial Rx parameter and the second spatial Rx parameter are respectively associated with different reference signal resources.

In one subembodiment, a Transmission Configuration Indication (TCI) State used by the first RE set is different from that used by the second RE set.

In one subembodiment, the first RE set is associated with a first reference signal resource, while the second RE set is associated with a second reference signal resource.

In one subsidiary embodiment of the above subembodiment, a radio signal transmitted in the first reference signal resource and a radio signal transmitted in the second reference signal resource are Non-Quasi Co-located (Non-QCL).

In one subsidiary embodiment of the above subembodiment, the first reference signal resource comprises a Channel-State Information Reference Signal (CSI-RS) Resource.

In one subsidiary embodiment of the above subembodiment, the first reference signal resource comprises a SS/PBCH Block (SSB).

In one subsidiary embodiment of the above subembodiment, the second reference signal resource comprises a CSI-RS resource.

In one subsidiary embodiment of the above subembodiment, the second reference signal resource comprises an SSB.

In one subsidiary embodiment of the above subembodiment, the first reference signal resource and the second reference signal resource are different.

In one subembodiment, the first RE set is associated with the first cell in the present application.

In one subembodiment, the second RE set is associated with the second cell in the present application.

In one subembodiment, the sentence that the first identity is used for the action of monitoring in the first RE set comprises: the first identity is used for de-scrambling the control signaling detected in the first RE set to determine whether the control signaling is the first signaling.

In one subembodiment, the sentence that the second identity is used for the action of monitoring in the second RE set comprises: the second identity is used for de-scrambling the control signaling detected in the second RE set to determine whether the control signaling is the first signaling.

In one subembodiment, when the first signaling is transmitted in the first RE set, CRC comprised in the first signaling is scrambled via the first identity.

In one subembodiment, when the first signaling is transmitted in the second RE set, CRC comprised in the first signaling is scrambled via the second identity.

In one embodiment, a signaling bearing the first information block comprises an RRC signaling.

In one embodiment, a signaling bearing the first information block comprises a MAC signaling.

In one embodiment, the first information block is used to indicate all identities comprised in the first identity set.

In one embodiment, the first identity and the second identity are respectively maintained by a first cell and a second cell, and an identifier corresponding to the first cell is different from that corresponding to the second cell.

In one subembodiment, the identifier corresponding to the first cell is a Physical Cell Identity (PCI).

In one subembodiment, the identifier corresponding to the second cell is a PCI.

In one subembodiment, the identifier corresponding to the first cell is a Cell Global ID (CGI).

In one subembodiment, the identifier corresponding to the second cell is a CGI.

In one subembodiment, the sentence that the first identity and the second identity are respectively maintained by a first cell and a second cell means that the first identity is allocated by the first cell, while the second identity is allocated by the second cell.

In one subembodiment, the sentence that the first identity and the second identity are respectively maintained by a first cell and a second cell means that the first cell ensures that the first identity is only assigned to a terminal under the first cell, and the second cell ensures that the second identity is only assigned to a terminal under the second cell.

In one embodiment, the first identity and the second identity are respectively assigned to the first node U1B and a second terminal, the first node U1B and the second terminal being two different terminals.

In one subembodiment, the first node U1B is a terminal different from the second terminal.

In one subembodiment, an International Mobile Subscriber Identity (IMSI) used by the first node U1B is different from that used by the second node.

In one subembodiment, a System Architecture Evolution Temporary Mobile Subscriber Identity (S-TMSI) used by the first node U1B is different from that used by the second node.

In one subembodiment, the first node U1B and the second terminal belong to a same terminal group.

In one embodiment, only when the first message is associated with downlink radio signal resources of a second cell can any identity comprised in the first identity set be used by the first node U1B to determine whether the first signaling is correctly received.

In one subembodiment, the first node U1B de-scrambles Cyclic Redundancy Check (CRC) of the first signaling by each identity comprised in the first identity set to determine whether the first signaling is correctly received.

In one subembodiment, any identity comprised in the first identity set can de-scramble CRC of the first signaling, and the first node determines that the first signaling is correctly received.

In one subembodiment, the sentence that the first message is associated with downlink radio signal resources of a second cell includes a meaning that time-frequency resources occupied by the first message are associated with downlink radio signal resources of the second cell.

In one subsidiary embodiment of the above subembodiment, time-frequency resources occupied by the first message are time-frequency resources in the second cell used for random access.

In one subsidiary embodiment of the above subembodiment, time-frequency resources occupied by the first message are Contention-Free.

In one subsidiary embodiment of the above subembodiment, time-frequency resources occupied by the first message are Contention-Based.

In one subembodiment, the sentence that the first message is associated with downlink radio signal resources of a second cell includes a meaning that the first message is used to indicate a target time-frequency resource set, the target time-frequency resource set belonging to downlink radio signal resources of the second cell.

In one subembodiment, downlink radio signal resources of the second cell comprise a CSI-RS resource of the second cell.

In one subembodiment, downlink radio signal resources of the second cell comprise an SSB of the second cell.

In one subembodiment, downlink radio signal resources of the second cell correspond to a CSI-RS resource index of the second cell.

In one subembodiment, downlink radio signal resources of the second cell correspond to an SSB index of the second cell.

In one subembodiment, when the first message is associated with downlink radio signal resources of a first cell, only the first identity comprised in the first identity set is used by the first node U1 to determine whether the first signaling is correctly received.

In one subsidiary embodiment of the above subembodiment, the first node U1 de-scrambles CRC of the first signaling via the first identity to determine whether the first signaling is correctly received.

In one subsidiary embodiment of the above subembodiment, when the first identity can de-scramble CRC of the first signaling, the first node U1 determines that the first signaling is correctly received.

In one subsidiary embodiment of the above subembodiment, the sentence that the first message is associated with downlink radio signal resources of a first cell includes a meaning that time-frequency resources occupied by the first message are associated with downlink radio signal resources of the first cell.

In one subsidiary embodiment of the above subembodiment, time-frequency resources occupied by the first message are time-frequency resources in the first cell used for random access.

In one subsidiary embodiment of the above subembodiment, the sentence that the first message is associated with downlink radio signal resources of a first cell includes a meaning that the first message is used to indicate a target time-frequency resource set, the target time-frequency resource set belonging to downlink radio signal resources of the first cell.

In one subsidiary embodiment of the above subembodiment, downlink radio signal resources of the first cell comprise a CSI-RS resource of the first cell.

In one subsidiary embodiment of the above subembodiment, downlink radio signal resources of the first cell comprise an SSB of the first cell.

In one subsidiary embodiment of the above subembodiment, downlink radio signal resources of the first cell correspond to a CSI-RS resource index of the first cell.

In one subsidiary embodiment of the above subembodiment, downlink radio signal resources of the first cell correspond to an SSB index of the first cell.

### Embodiment 6A

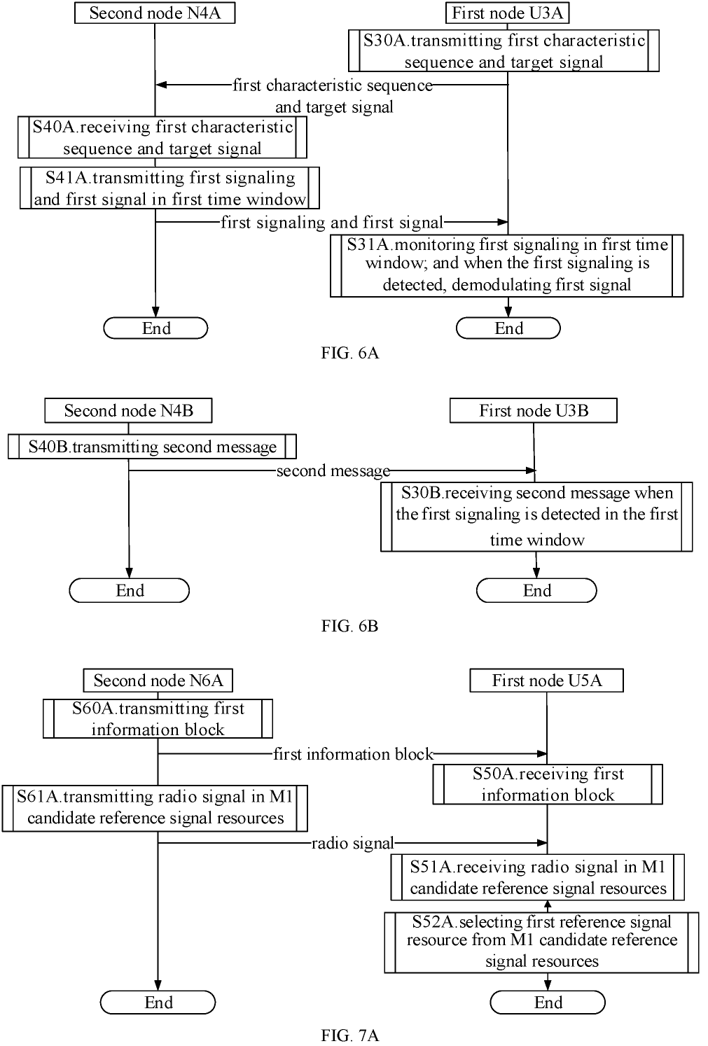

Embodiment 6A illustrates another flowchart of a first signal, as shown in FIG. 6A. In FIG. 6A, a first node U3A and a second node N4A are in communication via a radio link. It should be particularly noted that the sequence illustrated herein does not set any limit to the signal transmission order or implementation order in the present application. In case of no conflict, the embodiments, the subsidiary subembodiments and subsidiary embodiments provided in Embodiment 6A can be applied also in Embodiment 5A, Embodiment 7A and Embodiment 8A and Embodiment 9A.

The first node U3A transmits a first characteristic sequence and a target signal in step S30A; and in step S31A, monitors a first signaling in a first time window, and when the first signaling is detected, demodulates a first signal;

The second node N4A receives a first characteristic sequence and a target signal in step S40A; transmits a first signaling and a first signal in a first time window in step S41A.

In Embodiment 6A, a channel occupied by the first characteristic sequence includes a random access (RA)-related channel, a transmission timing of the target signal is related to a transmission timing of the first characteristic sequence; the target signal comprises a first identifier, while the first signal comprises the first identifier and a second identifier, and Cyclic Redundancy Check (CRC) comprised in the first signaling is scrambled by a third identifier; the first signaling comprises configuration information of the first signal, the configuration information comprising a time-frequency resource set occupied by the first signal; the target signal is used to trigger the first signal; the first identifier is a Cell-Radio Network Temporary Identity (C-RNTI), the second identifier is a C-RNTI, and the third identifier is an RNTI different from the first identifier; the first time window is related to a time-domain resource occupied by the target signal.

In one embodiment, the first characteristic sequence and the target signal belong to a same message MSGA, with the third identifier being a MSGB-RNTI.

In one embodiment, the first time window is a msgB-ResponseWindow.

In one embodiment, the first signal comprises an MsgB.

### Embodiment 6B

Embodiment 6B illustrates a flowchart of a second message, as shown in FIG. 6B. In FIG. 6B, a first node U3B and a second node N4B are in communication via a radio link. It should be particularly noted that the sequence illustrated herein does not set any limit to the signal transmission order or implementation order in the present application. In case of no conflict, the embodiments, the subsidiary subembodiments and subsidiary embodiments provided in Embodiment 6B can be applied also in Embodiment 5B and Embodiment 7B.

The first node U3B receives a second message in step S30B when the first signaling is detected in the first time window.

The second node N4B transmits a second message in step S40B.

In Embodiment 6B, the first signaling comprises configuration information of a channel occupied by the second message, the second message comprising the any identity in the first identity set.

In one embodiment, the channel occupied by the second message includes a Physical Downlink Shared Channel (PDSCH).

In one embodiment, the channel occupied by the second message includes a Physical Sidelink Shared Channel (PSSCH).

In one embodiment, the second message is an Msg4.

In one embodiment, the second message is an MsgB.

In one embodiment, the second message is a Contention Resolution.

In one embodiment, the second message comprises a MAC PDU.

In one embodiment, the second message comprises a Contention Resolution Identity MAC Control Element of the first node U3B.

In one embodiment, the second message comprises a C-RNTI MAC CE.

In one embodiment, the first signaling is used to schedule a PDSCH occupied by the second message.

### Embodiment 7A

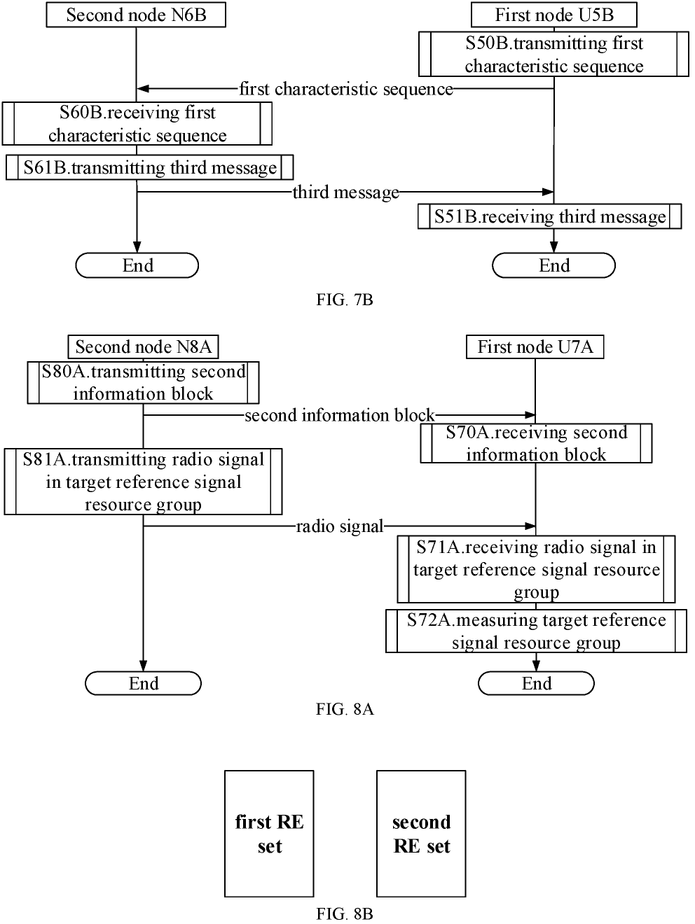

Embodiment 7A illustrates a flowchart of a first information block, as shown in FIG. 7A. In FIG. 7A, a first node U5A and a second node N6A are in communication via a radio link. It should be particularly noted that the sequence illustrated herein does not set any limit to the signal transmission order or implementation order in the present application. In case of no conflict, the embodiments, the subsidiary subembodiments and subsidiary embodiments provided in Embodiment 7A can be applied also in Embodiment 5A, Embodiment 6A and Embodiment 8A and Embodiment 9A.

The first node U5A receives a first information block in step S50A, receives radio signals in M1 candidate reference signal resources in step S51A and selects a first reference signal resource from M1 candidate reference signal resources in step S52A.

The second node N6A transmits a first information block in step S60A, and transmits a radio signal in M1 candidate reference signal resources in step S61A.

In Embodiment 7A, the first reference signal resource is a candidate reference signal resource among the M1 candidate reference signal resources; a transmitter of the first information block is the first cell; M1 is a positive integer greater than 1.

In one embodiment, a radio signal transmitted in the M1 candidate reference signal resources comprises a CSI-RS.

In one embodiment, a radio signal transmitted in the M1 candidate reference signal resources comprises an SSB.

In one embodiment, the first information block is an RRC signaling.

In one embodiment, the first information block is specific to the second cell in the present application.

In one embodiment, the first information block comprises a higher-layer signaling.

In one embodiment, an RRC signaling bearing the first information block comprises a candidateBeamRSList.

In one embodiment, an RRC signaling bearing the first information block comprises a BeamFailureRecoveryConfig.

In one embodiment, an RRC signaling bearing the first information block comprises an SSB.

In one embodiment, an RRC signaling bearing the first information block comprises ControlResourceSet Information Elements (IE).

In one embodiment, an RRC signaling bearing the first information block comprises a SearchSpace IE.

In one embodiment, an RRC signaling bearing the first information block comprises a PDCCH-ConfigCommon IE.

In one embodiment, an RRC signaling bearing the first information block comprises a BWP-DownlinkCommon IE.

In one embodiment, an RRC signaling bearing the first information block comprises a CSI-IM-Resource IE.

In one embodiment, an RRC signaling bearing the first information block comprises a CSI-MeasConfig IE.

In one embodiment, an RRC signaling bearing the first information block comprises a CSI-ResourceConfig IE.

In one embodiment, an RRC signaling bearing the first information block comprises a CSI-ResourceConfigMobility IE.

In one embodiment, an RRC signaling bearing the first information block comprises a CSI-SSB-ResourceSet IE.

In one embodiment, names of an RRC signaling bearing the first information block include CSI.

In one embodiment, names of an RRC signaling bearing the first information block include RS.

In one embodiment, names of an RRC signaling bearing the first information block include Resource.

In one embodiment, names of an RRC signaling bearing the first information block include Mobility.

In one embodiment, names of an RRC signaling bearing the first information block include at least one of L1 or L2.

In one embodiment, names of an RRC signaling bearing the first information block include at least one of L1 or L2.

In one embodiment, names of an RRC signaling bearing the first information block include Intercell.

In one embodiment, any candidate reference signal resource among the M1 candidate reference signal resources comprises a CSI-RS.

In one embodiment, any candidate reference signal resource among the M1 candidate reference signal resources comprises an SSB.

In one embodiment, any candidate reference signal resource among the M1 candidate reference signal resources comprises a CSI-RS resource.

In one embodiment, any candidate reference signal resource among the M1 candidate reference signal resources comprises an SSB resource.

In one embodiment, at least one candidate reference signal resource among the M1 candidate reference signal resources comprises a CSI-RS.

In one embodiment, at least one candidate reference signal resource among the M1 candidate reference signal resources comprises an SSB.

In one embodiment, at least one candidate reference signal resource among the M1 candidate reference signal resources comprises a CSI-RS resource.

In one embodiment, at least one candidate reference signal resource among the M1 candidate reference signal resources comprises an SSB resource.

In one embodiment, any candidate reference signal resource among the M1 candidate reference signal resources corresponds to a CSI-RS resource identifier.

In one embodiment, any candidate reference signal resource among the M1 candidate reference signal resources corresponds to an SSB index.

In one embodiment, any candidate reference signal resource among the M1 candidate reference signal resources corresponds to a CSI-RS resource set identifier.

In one embodiment, at least one candidate reference signal resource among the M1 candidate reference signal resources corresponds to a CSI-RS resource identifier.

In one embodiment, at least one candidate reference signal resource among the M1 candidate reference signal resources corresponds to an SSB index.

In one embodiment, at least one candidate reference signal resource among the M1 candidate reference signal resources corresponds to a CORESET identifier.

In one embodiment, at least one candidate reference signal resource among the M1 candidate reference signal resources corresponds to a CORESET pool identifier.

In one embodiment, at least one candidate reference signal resource among the M1 candidate reference signal resources corresponds to a search space set identifier.

In one embodiment, at least one candidate reference signal resource among the M1 candidate reference signal resources corresponds to a search space set pool identifier.

In one embodiment, the M1 candidate reference signal resources are all maintained by the second cell.

In one embodiment, at least one candidate reference signal resource among the M1 candidate reference signal resources is maintained by the first cell.

In one embodiment, M1 is no greater than 1024.

In one embodiment, M1 is no greater than 64.

In one embodiment, how to select the first reference signal resource is dependent on implementation, which means it is determined by the equipment manufacturer itself.

In one subembodiment, there is no candidate reference signal resource among the M1 candidate reference signal resources of which the channel quality exceeds a specific threshold.

In one embodiment, the first reference signal resource has a highest channel quality among the M1 candidate reference signal resources.

In one embodiment, among the M1 candidate reference signal resources there is(are) only M3 candidate reference signal resource(s) with channel quality(qualities) exceeding a specific threshold, and the first reference signal resource can only be selected from the M3 candidate reference signal resource(s), M3 being a positive integer.

In one embodiment, M3 is a positive integer greater than 1, thus how to select the first reference signal resource from the M3 candidate reference signal resources is dependent on implementation, which means it is determined by the equipment manufacturer itself.

In one embodiment, among the M1 candidate reference signal resources any reference signal resource maintained by the first cell will be preferred for selection.

In one subembodiment, only when there is merely the first reference signal resource of which the channel quality exceeds a specific threshold among the M1 candidate reference signal resources will the first reference signal resource be selected.

In one embodiment, the specific threshold in the present application is configurable.

In one embodiment, the specific threshold in the present application is fixed.

In one embodiment, the specific threshold in the present application is a rsrp-ThresholdCSI-RS or rsrp-ThresholdSSB.

In one embodiment, the specific threshold in the present application is a Reference Signal Received Power (RSRP).

In one embodiment, the specific threshold in the present application is a Reference Signal Received Quality (RSRQ).

In one embodiment, the specific threshold in the present application is a Received Signal Strength Indicator (RSSI).

In one embodiment, the specific threshold in the present application is a Block Error Rate (BLER).

In one embodiment, the specific threshold in the present application is a Signal-to-noise and interference ratio (SINR).

In one embodiment, the specific threshold in the present application is a Signal-to-noise ratio (SNR).

In one embodiment, the specific threshold in the present application is measured in dBm.

In one embodiment, the specific threshold in the present application is measured in dB.

In one embodiment, the specific threshold in the present application is measured in mW.

In one embodiment, the specific threshold in the present application is percentage.

In one embodiment, the first information block indicates a cell identity of the second cell for M2 candidate reference signal resource(s) among the M1 candidate reference signal resources, M2 being a positive integer no greater than M1.

In one embodiment, the channel quality in the present application comprises an RSRP.

In one embodiment, the channel quality in the present application comprises an RSRQ.

In one embodiment, the channel quality in the present application comprises an RSSI.

In one embodiment, the channel quality in the present application comprises a BLER.

In one embodiment, the channel quality in the present application comprises an SNR.

In one embodiment, the channel quality in the present application comprises a SINR.

### Embodiment 7B

Embodiment 7B illustrates a flowchart of a first characteristic sequence, as shown in FIG. 7B. In FIG. 7B, a first node U5B and a second node N6B are in communication via a radio link. It should be particularly noted that the sequence illustrated herein does not set any limit to the signal transmission order or implementation order in the present application. In case of no conflict, the embodiments, the subsidiary subembodiments and subsidiary embodiments provided in Embodiment 7B can be applied also in Embodiment 5B and Embodiment 6B.

The first node U5B transmits a first characteristic sequence in step S50B, and receives a third message in step S51B.

The second node N6B receives a first characteristic sequence in step S60B, and transmits a third message in step S61B.

In Embodiment 7B, the first characteristic sequence is used to trigger the third message, the third message being used to trigger the first message.

In one embodiment, the first characteristic sequence is a Preamble.

In one embodiment, the first characteristic sequence is an Msg1.

In one embodiment, a physical layer channel bearing the first characteristic sequence comprises a PRACH.

In one embodiment, the first characteristic sequence is used for a random access procedure.

In one embodiment, an MsgA comprises the first characteristic sequence.

In one embodiment, the first characteristic sequence is associated with a CSI-RS resource of a first cell.

In one embodiment, the first characteristic sequence is associated with an SSB of a first cell.

In one embodiment, time-frequency resources occupied by the first characteristic sequence are associated with a CSI-RS resource of a first cell.

In one embodiment, time-frequency resources occupied by the first characteristic sequence are associated with an SSB of a first cell.

In one embodiment, the third message is an Msg2.

In one embodiment, the third message comprises an RAR.

In one embodiment, the third message comprises an RAR in response to the first characteristic sequence.

In one embodiment, a physical layer channel bearing the third message is a PDSCH, and CRC comprised in a physical layer control channel scheduling the PDSCH of the third message is scrambled by a RA-RNTI.

In one embodiment, the first characteristic sequence, the third message, the first message and the second message respectively comprise an Msg1, an Msg2, an Msg3 and an Msg4.

In one embodiment, transmission of the first characteristic sequence is used to trigger reception of the third message.

In one embodiment, reception of the third message is used to trigger transmission of the first message.

### Embodiment 8A

Embodiment 8A illustrates a flowchart of a second information block and a second information block, as shown in FIG. 8A. In FIG. 8A, a first node U7A and a second node N8A are in communication via a radio link. It should be particularly noted that the sequence illustrated herein does not set any limit to the signal transmission order or implementation order in the present application. In case of no conflict, the embodiments, the subsidiary subembodiments and subsidiary embodiments provided in Embodiment 8A can be applied also in Embodiment 5A, Embodiment 6A and Embodiment 7A and Embodiment 9A.

The first node U7A receives a second information block in step S70A, receives a radio signal in a target reference signal resource group in step S71A, and measures the target reference signal resource group in step S72A.

The second node N8A transmits a second information block in step S80A, and transmits a radio signal in a target reference signal resource group in step S81A.

In Embodiment 8A, the second information block indicates the target reference signal resource group, where a channel quality of each reference signal resource in the target reference signal resource group is lower than a first threshold, and a first counter is incremented by 1; the target reference signal resource group comprises at least one reference signal resource, as the first counter reaches a first trigger value, a transmission of the first characteristic sequence is triggered.

In one embodiment, a radio signal transmitted in the target reference signal resource group comprises a CSI-RS.

In one embodiment, a radio signal transmitted in the target reference signal resource group comprises an SSB.

In one embodiment, measuring the target reference signal resource group includes measuring the channel quality of a radio signal transmitted in the target reference signal resource group.

In one embodiment, the target reference signal resource group is maintained by the first cell in the present application.

In one embodiment, the target reference signal resource group comprises N1 first-type reference signal resource(s), N1 being a positive integer.

In one subembodiment, the N1 first-type reference signal resource(s) is(are) maintained by the first cell in the present application.

In one subembodiment, there is at least one first-type reference signal resource of the N1 first-type reference signal resource(s) being maintained by the second cell in the present application.

In one subembodiment, N1 is equal to 1.

In one subembodiment, N1 is a positive integer greater than 1.

In one subembodiment, N1 is no greater than 1024.

In one subembodiment, N1 is no greater than 64.

In one subembodiment, any of the N1 first-type reference signal resource(s) comprises a CSI-RS.

In one subembodiment, any of the N1 first-type reference signal resource(s) comprises an SSB.

In one subembodiment, any of the N1 first-type reference signal resource(s) comprises a CSI-RS resource.

In one subembodiment, any of the N1 first-type reference signal resource(s) comprises an SSB resource.

In one subembodiment, any of the N1 first-type reference signal resource(s) comprises a CSI-RS.

In one subembodiment, at least one of the N1 first-type reference signal resource(s) comprises an SSB.

In one subembodiment, at least one of the N1 first-type reference signal resource(s) comprises a CSI-RS resource.

In one subembodiment, at least one of the N1 first-type reference signal resource(s) comprises an SSB resource.

In one subembodiment, any of the N1 first-type reference signal resource(s) corresponds to a CSI-RS resource identifier.

In one subembodiment, any of the N1 first-type reference signal resource(s) corresponds to an SSB index.

In one subembodiment, any of the N1 first-type reference signal resource(s) corresponds to a CSI-RS resource set identifier.

In one subembodiment, at least one of the N1 first-type reference signal resource(s) corresponds to a CSI-RS resource identifier.

In one subembodiment, at least one of the N1 first-type reference signal resource(s) corresponds to an SSB index.

In one subembodiment, at least one of the N1 first-type reference signal resource(s) corresponds to a CORESET identifier.

In one subembodiment, at least one of the N1 first-type reference signal resource(s) corresponds to a CORESET pool identifier.

In one subembodiment, at least one of the N1 first-type reference signal resource(s) corresponds to a search space set identifier.

In one subembodiment, at least one of the N1 first-type reference signal resource(s) corresponds to a search space set pool identifier.

In one embodiment, as a response to that the channel quality of each reference signal resource in the target reference signal resource group is lower than a first threshold, an indication is sent to a higher layer, and the higher layer then increments the first counter by 1 according to the indication received.

In one embodiment, the higher layer is a MAC layer.

In one embodiment, the higher layer belongs to L2.

In one embodiment, the first counter is a BFI_COUNTER.

In one embodiment, the first trigger value is configurable.

In one embodiment, the first trigger value is configurable.

In one embodiment, the first trigger value is beamFailureInstanceMaxCount.

In one embodiment, the first trigger value is equal to 1.

In one embodiment, the first trigger value is a positive integer greater than 1.

In one embodiment, the second information block comprises failureDetectionResources.

In one embodiment, the second information block comprises a beamFailureDetectionResourceList.

In one embodiment, an RRC signaling bearing the second information block comprises a candidateBeamRSList.

In one embodiment, an RRC signaling bearing the second information block comprises a BeamFailureRecoveryConfig.

In one embodiment, an RRC signaling bearing the second information block comprises an SSB.

In one embodiment, an RRC signaling bearing the second information block comprises a ControlResourceSet IE.

In one embodiment, an RRC signaling bearing the second information block comprises a SearchSpace IE.

In one embodiment, an RRC signaling bearing the second information block comprises a PDCCH-ConfigCommon IE.

In one embodiment, an RRC signaling bearing the second information block comprises a BWP-DownlinkCommon IE.

In one embodiment, an RRC signaling bearing the second information block comprises a CSI-IM-Resource IE.

In one embodiment, an RRC signaling bearing the second information block comprises a CSI-MeasConfig IE.

In one embodiment, an RRC signaling bearing the second information block comprises a CSI-ResourceConfig IE.

In one embodiment, an RRC signaling bearing the second information block comprises a CSI-ResourceConfigMobility IE.

In one embodiment, an RRC signaling bearing the second information block comprises a CSI-SSB-ResourceSet IE.

In one embodiment, names of an RRC signaling bearing the second information block include CSI.

In one embodiment, names of an RRC signaling bearing the second information block include RS.

In one embodiment, names of an RRC signaling bearing the second information block include Resource.

In one embodiment, names of an RRC signaling bearing the second information block include Mobility.

In one embodiment, names of an RRC signaling bearing the second information block include at least one of L1 or L2.

In one embodiment, names of an RRC signaling bearing the second information block include at least one of L1 or L2.

In one embodiment, names of an RRC signaling bearing the second information block include Intercell.

In one embodiment, the first threshold in the present application is configurable.

In one embodiment, the first threshold in the present application is fixed.

In one embodiment, the first threshold in the present application is a rsrp-ThresholdCSI-RS or rsrp-ThresholdSSB.

In one embodiment, the first threshold in the present application is an RSRP.

In one embodiment, the first threshold in the present application is an RSRQ.

In one embodiment, the first threshold in the present application is an RSSI.

In one embodiment, the first threshold in the present application is a BLER.

In one embodiment, the first threshold in the present application is a SINR.

In one embodiment, the first threshold in the present application is an SNR.

In one embodiment, the first threshold in the present application is measured in dBm.

In one embodiment, the first threshold in the present application is measured in dB.

In one embodiment, the first threshold in the present application is measured in mW.

In one embodiment, the first threshold in the present application is percentage.

### Embodiment 8B

Embodiment 8B illustrates a schematic diagram of a first RE set and a second RE set, as shown in FIG. 8B. In FIG. 8B, the first RE set occupies more than one RE, and the second RE set occupies more than one RE.

In one embodiment, the first RE set and the second RE set are respectively allocated to the first cell and the second cell in the present application.

In one embodiment, the first RE set and the second RE set are maintained by a same base station, the base station simultaneously maintaining the first cell and the second cell in the present application.

In one embodiment, the first RE set and the second RE set are Time Division Multiplexing (TDM).

In one embodiment, the first RE set and the second RE set are Frequency Division Multiplexing (FDM).

In one embodiment, the first RE set and the second RE set are Space Division Multiplexing (SDM).

In one embodiment, the first RE set and the second RE set are Code Division Multiplexing (CDM).

### Embodiment 9A

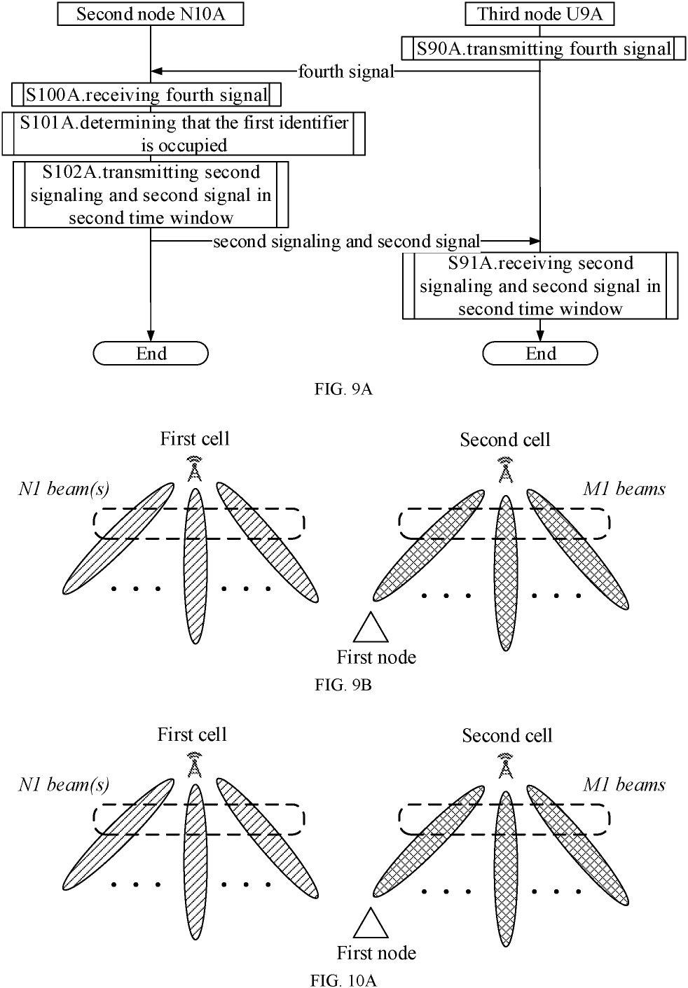

Embodiment 9A illustrates a flowchart of a second signaling, as shown in FIG. 9A. In FIG. 9A, a third node U9A and a second node N10A are in communication via a radio link. It should be particularly noted that the sequence illustrated herein does not set any limit to the signal transmission order or implementation order in the present application. In case of no conflict, the embodiments, the subsidiary subembodiments and subsidiary embodiments provided in Embodiment 9A can be applied also in Embodiment 5A, Embodiment 6A and Embodiment 7A and Embodiment 8A.

The third node U9A transmits a fourth signal in step S90A, and receives a second signaling and a second signal in a second time window in step S91A.

The second node N10A receives a fourth signal in step S100A, determines that the first identifier is occupied in step S101A, and transmits a second signaling and a second signal in a second time window in step S102A.

In Embodiment 9A, the fourth signal carries the first identifier, and CRC comprised in the second signaling is scrambled via the first identifier; the second signaling comprises configuration information of the second signal, the configuration information comprising a time-frequency resource set occupied by the second signal; the target signal is used to trigger the second signal.

In one embodiment, the third node U9A and the first node in the present application are respectively two different terminals.

In one embodiment, the phrase of determining that the first identifier is occupied means that: the second node N10A determines that the first identifier is allocated to the third node U9A by the second node N10A.

In one embodiment, the third node U9A is a terminal other than the first node in the present application.

In one embodiment, the third node U9A establishes an RRC connection to the second node N10A.

In one embodiment, the third node U9A is served by the second node N10A.

In one embodiment, a serving cell of the third node U9A is the second node N10A.

In one embodiment, the phrase of determining that the first identifier is occupied means that: the first identifier is already used by the second node N10A.

In one embodiment, time resources occupied by the first time window and time resources occupied by the second time window are the same.

In one embodiment, time resources occupied by the first time window and time resources occupied by the second time window are orthogonal.

In one embodiment, the second time window occupies a positive integer number of consecutive slots.

In one embodiment, the fourth signal is an Msg2.

In one embodiment, the fourth signal is an MsgA.

In one embodiment, the second signal is an Msg4.

In one embodiment, the second signal is a Contention Resolution.

In one embodiment, the second signal is an MsgB.

In one embodiment, the second signal is used for a random access procedure.

In one embodiment, the second signal comprises a MAC PDU.

In one embodiment, the second signal comprises a Contention Resolution Identity MAC Control Element of the first node.

In one embodiment, the second signal comprises a C-RNTI MAC CE.

### Embodiment 9B

Embodiment 9B illustrates a schematic diagram of a first cell and a second cell, as shown in FIG. 9B. In FIG. 9B, the first node in the present application is camped on a first cell, a second cell in FIG. 9B being a neighboring cell of the first cell; the second cell maintains transmissions of M1 beams, the M1 beams respectively corresponding to M1 candidate reference signal resources, and the second cell transmitting M1 candidate reference signals respectively on the M1 candidate reference signal resources to be used for Beam Management at the terminal side; the first cell maintains transmissions of N1 beams, the N1 beams respectively corresponding to N1 first-type reference signal resources comprised in a target reference signal resource group, and the first cell transmitting N1 first-type reference signals respectively on the N1 first-type reference signal resources to be used for Beam Management at the terminal side. The first node finds that channel quality detected in each of the N1 first-type reference signals is lower than a first threshold, and among the M1 candidate reference signals there is at least one candidate reference signal in which the channel quality is higher than a specific threshold. The first node starts to transmit the first message in the present application.

In one embodiment, the first cell maintains the first identity.

In one embodiment, the first cell maintains the first RE set.

In one embodiment, the second cell maintains the second identity.

In one embodiment, the second cell maintains the second RE set.

In one embodiment, the second cell transmits the first signaling.

In one embodiment, time-frequency resources occupied by a random access procedure initiated by the first node belong to the second cell.

### Embodiment 10A

Embodiment 10A illustrates a schematic diagram of a first cell and a second cell, as shown in FIG. 10A. In FIG. 10A, the first node in the present application is camped on a first cell, a second cell in this figure being a neighboring cell of the first cell; the second cell maintains transmissions of M1 beams, the M1 beams respectively corresponding to M1 candidate reference signal resources, and the second cell transmitting M1 candidate reference signals respectively on the M1 candidate reference signal resources to be used for Beam Management at the terminal side; the first cell maintains transmissions of N1 beams, the N1 beams respectively corresponding to N1 first-type reference signal resources comprised in a target reference signal resource group, and the first cell transmitting N1 first-type reference signals respectively on the N1 first-type reference signal resources to be used for Beam Management at the terminal side. The first node finds that channel quality detected in each of the N1 first-type reference signals is lower than a first threshold, and among the M1 candidate reference signals there is at least one candidate reference signal in which the channel quality is higher than a specific threshold. The first node initiates L1/L2 cell handover from the first cell to the second cell.

### Embodiment 10B

Embodiment 10B illustrates a structure block diagram of a first node, as shown in FIG. 10B. In FIG. 10B, a first node 1000B comprises a first transceiver 1001B, a first receiver 1002B and a second receiver 1003B.

The first transceiver 1001B transmits a first message via an air interface, the first message comprising a first identity; and

The first receiver 1002B monitors a first signaling via an air interface in a first time window, the first signaling being identified by any identity in a first identity set; and

The second receiver 1003B, when the first signaling is detected in the first time window, determines that a random access (RA) procedure to which the first message belongs is successful; when the first signaling is not detected in the first time window, determining that the RA procedure to which the first message belongs is unsuccessful.

In Embodiment 10B, the first identity is a C-RNTI, the first identity set comprising multiple identities, and any identity in the first identity set being an RNTI; a time-domain resource occupied by the first message is used to determine the first time window.

In one embodiment, when the first signaling is detected in the first time window, the second receiver 1003B receives a second message; the first signaling comprises configuration information of a channel occupied by the second message, the second message comprising the any identity in the first identity set.

In one embodiment, the action of monitoring a first signaling via an air interface in a first time window comprises: monitoring the first signaling respectively in a first RE set and a second RE set in the first time window; the first identity is used for the monitoring action in the first RE set, while a second identity is used for the monitoring action in the second RE set, the first identity set comprising the first identity and the second identity.

In one embodiment, the first transceiver 1001B transmits a first characteristic sequence, and the first transceiver 1001B receives a third message; the first characteristic sequence is used to trigger the third message, the third message being used to trigger the first message.

In one embodiment, the first transceiver 1001B receives a first information block; the first information block is used to indicate the first identity set.

In one embodiment, the first identity and the second identity are respectively maintained by a first cell and a second cell, and an identifier corresponding to the first cell is different from that corresponding to the second cell.

In one embodiment, the first identity and the second identity are respectively assigned to the first node and a second terminal, the first node and the second terminal being two different terminals.

In one embodiment, only when the first message is associated with downlink radio signal resources of a second cell can any identity comprised in the first identity set be used by the first node to determine whether the first signaling is correctly received.

In one embodiment, the first transceiver 1001B comprises at least the first six of the antenna 452, the receiver/transmitter 454, the multi-antenna receiving processor 458, the multi-antenna transmitting processor 457, the receiving processor 456, the transmitting processor 468 and the controller/processor 459 in Embodiment 4.

In one embodiment, the first receiver 1002B comprises at least the first four of the antenna 452, the receiver 454, the multi-antenna receiving processor 458, the receiving processor 456 and the controller/processor 459 in Embodiment 4.

In one embodiment, the second receiver 1003B comprises at least the first four of the antenna 452, the receiver 454, the multi-antenna receiving processor 458, the receiving processor 456 and the controller/processor 459 in Embodiment 4.

### Embodiment 11A

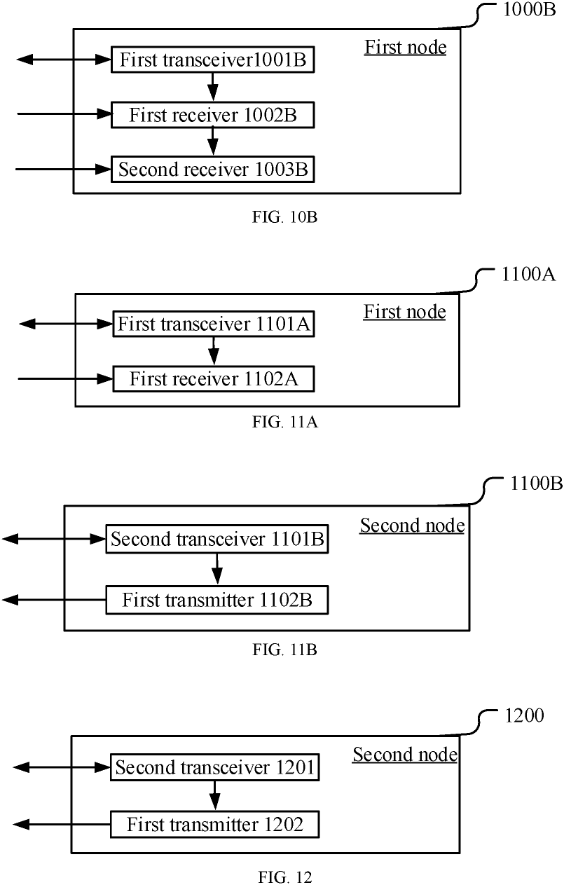

Embodiment 11A illustrates a structure block diagram of a first node, as shown in FIG. 11A. In FIG. 11A, a first node 1100A comprises a first transceiver 1101A and a first receiver 1102A.

The first transceiver 1101A transmits a first characteristic sequence and a target signal; and

The first receiver 1102A monitors a first signaling in a first time window; and when the first signaling is detected, demodulates a first signal.

In Embodiment 11A, a channel occupied by the first characteristic sequence includes a random access (RA)-related channel, a transmission timing of the target signal is related to a transmission timing of the first characteristic sequence; the target signal comprises a first identifier, while the first signal comprises the first identifier and a second identifier, and Cyclic Redundancy Check (CRC) comprised in the first signaling is scrambled by a third identifier; the first signaling comprises configuration information of the first signal, the configuration information comprising a time-frequency resource set occupied by the first signal; the target signal is used to trigger the first signal; the first identifier is a Cell-Radio Network Temporary Identity (C-RNTI), the second identifier is a C-RNTI, and the third identifier is an RNTI different from the first identifier; the first time window is related to a time-domain resource occupied by the target signal.

In one embodiment, the first characteristic sequence and the target signal belong to a same message MSGA, with the third identifier being a MSGB-RNTI.

In one embodiment, the first transceiver 1101A receives a third signal after the first characteristic sequence is transmitted and before the target signal is transmitted; the first characteristic sequence is used to trigger the third signal, the third signal indicating the third identifier.

In one embodiment, the first identifier is configured by a first cell, while the second identifier and third identifier are configured by a second cell, the first cell being different from the second cell; a first radio resource is used to determine a first reference signal resource, the first radio resource comprising at least one of a time-domain resource occupied by the first characteristic sequence, a frequency-domain resource occupied by the first characteristic sequence or a preamble index of the first characteristic sequence; or, the target signal comprises a first information element, the first information element in the target signal being used to indicate a first reference signal resource; the first reference signal resource is maintained by the second cell.

In one embodiment, the first transceiver 1101A receives a first information block, the first information block being used to indicate M1 candidate reference signal resources; and the first transceiver 1101A selects the first reference signal resource from the M1 candidate reference signal resources; the first reference signal resource is a candidate reference signal resource among the M1 candidate reference signal resources; a transmitter of the first information block is the first cell; M1 is a positive integer greater than 1.

In one embodiment, the first transceiver 1101A receives a second information block, the second information block indicating a target reference signal resource group; and the first transceiver measures the target reference signal resource group, where a channel quality of each reference signal resource in the target reference signal resource group is lower than a first threshold, and a first counter is incremented by 1; the target reference signal resource group comprises at least one reference signal resource, as the first counter reaches a first trigger value, a transmission of the first characteristic sequence is triggered.

In one embodiment, the action of demodulating a first signal comprises attempting to recover a first MAC Protocol Data Unit (PDU), the first MAC PDU comprising the first identifier and the second identifier; only when the first MAC PDU is recovered will it be determined that a random access (RA) procedure to which the first characteristic sequence belongs is successful.

In one embodiment, the first transceiver 1101A comprises at least the first six of the antenna 452, the receiver/transmitter 454, the multi-antenna receiving processor 458, the multi-antenna transmitting processor 457, the receiving processor 456, the transmitting processor 468 and the controller/processor 459 in Embodiment 4.

In one embodiment, the first receiver 1102A comprises at least the first four of the antenna 452, the receiver 454, the multi-antenna receiving processor 458, the receiving processor 456 and the controller/processor 459 in Embodiment 4.

### Embodiment 11B

Embodiment 11B illustrates a structure block diagram of a second node, as shown in FIG. 11B. In FIG. 11B, a second node 1100B comprises a second transceiver 1101B and a first transmitter 1102B.

The second transceiver 1101B receives a first message via an air interface, the first message comprising a first identity;

The first transmitter 1102B transmits a first signaling via an air interface in a first time window, the first signaling being identified by any identity in a first identity set.

In Embodiment 11B, when the first signaling is detected in the first time window, a transmitter of the first message determines that a random access (RA) procedure to which the first message belongs is successful; when the first signaling is not detected in the first time window, a transmitter of the first message determines that the RA procedure to which the first message belongs is unsuccessful; the first identity is a C-RNTI, the first identity set comprising multiple identities, and any identity in the first identity set being an RNTI; a time-domain resource occupied by the first message is used to determine the first time window.

In one embodiment, the first transmitter 1102B transmits a second message; the first signaling comprises configuration information of a channel occupied by the second message, the second message comprising the any identity in the first identity set.

In one embodiment, the second node transmits the first signaling in at least one of a first RE set or a second RE set in the first time window; when the first signaling is transmitted in the first RE set, the first identity is used for scrambling CRC comprised in the first signaling; when the first signaling is transmitted in the second RE set, a second identity is used for scrambling CRC comprised in the first signaling; the first identity set comprises the first identity and the second identity.

In one embodiment, the second transceiver 1101B receives a first characteristic sequence, and the second transceiver 1101 transmits a third message; the first characteristic sequence is used to trigger the third message, the third message being used to trigger the first message.

In one embodiment, the second transceiver 1101B transmits a first information block; the first information block is used to indicate the first identity set.

In one embodiment, the first identity and the second identity are respectively maintained by a first cell and a second cell, and an identifier corresponding to the first cell is different from that corresponding to the second cell.

In one embodiment, the first identity and the second identity are respectively maintained by a first cell and a second cell, and an identifier corresponding to the first cell is different from that corresponding to the second cell.

In one embodiment, the first identity and the second identity are respectively assigned to the first node and a second terminal, the first node and the second terminal being two different terminals.

In one embodiment, only when the first message is associated with downlink radio signal resources of a second cell can any identity comprised in the first identity set be used by the second node for scrambling CRC comprised in the first signaling.

In one embodiment, the second transceiver 1101B comprises at least the first six of the antenna 420, the receiver 418, the multi-antenna receiving processor 472, the receiving processor 470, the transmitter 418, the multi-antenna transmitting processor 471, the transmitting processor 416 or the controller/processor 475 in Embodiment 4.

In one embodiment, the first transmitter 1102B comprises at least the first four of the antenna 420, the transmitter 418, the multi-antenna transmitting processor 471, the transmitting processor 416 and the controller/processor 475 in Embodiment 4.

### Embodiment 12

Embodiment 12 illustrates a structure block diagram of a second node, as shown in FIG. 12. In FIG. 12, a second node 1200 comprises a second transceiver 1201 and a first transmitter 1202.

The second transceiver 1201 receives a first characteristic sequence and a target signal; and

The first transmitter 1202 transmits a first signaling in a first time window; and transmits a first signal.

In Embodiment 12, a channel occupied by the first characteristic sequence includes a random access (RA)-related channel, a transmission timing of the target signal is related to a transmission timing of the first characteristic sequence; the target signal comprises a first identifier, while the first signal comprises the first identifier and a second identifier, and Cyclic Redundancy Check (CRC) comprised in the first signaling is scrambled by a third identifier; the first signaling comprises configuration information of the first signal, the configuration information comprising a time-frequency resource set occupied by the first signal; the target signal is used to trigger the first signal; the first identifier is a Cell-Radio Network Temporary Identity (C-RNTI), the second identifier is a C-RNTI, and the third identifier is an RNTI different from the first identifier; the first time window is related to a time-domain resource occupied by the target signal.

In one embodiment, the first characteristic sequence and the target signal belong to a same message MSGA, with the third identifier being a MSGB-RNTI.

In one embodiment, the second transceiver 1201 transmits a third signal after the first characteristic sequence is received and before the target signal is received; the first characteristic sequence is used to trigger the third signal, the third signal indicating the third identifier.

In one embodiment, the first identifier is configured by a first cell, while the second identifier and third identifier are configured by a second cell, the first cell being different from the second cell; a first radio resource is used to determine a first reference signal resource, the first radio resource comprising at least one of a time-domain resource occupied by the first characteristic sequence, a frequency-domain resource occupied by the first characteristic sequence or a preamble index of the first characteristic sequence; or, the target signal comprises a first information element, the first information element in the target signal being used to indicate a first reference signal resource; the first reference signal resource is maintained by the second cell.

In one embodiment, the second transceiver 1201 transmits a first information block, the first information block being used to indicate M1 candidate reference signal resources; the first reference signal resource is a candidate reference signal resource among the M1 candidate reference signal resources; a transmitter of the first information block is the first cell; M1 is a positive integer greater than 1.

In one embodiment, the second transceiver 1201 transmits a second information block, the second information block indicating a target reference signal resource group; a transmitter of the first characteristic sequence is a first node, the first node measuring the target reference signal resource group, where a channel quality of each reference signal resource in the target reference signal resource group is lower than a first threshold, and a first counter of the first node is incremented by 1; the target reference signal resource group comprises at least one reference signal resource, the first counter reaches a first trigger value, and the first characteristic sequence is triggered.

In one embodiment, the second transceiver 1201 determines that the first identifier is occupied; and the second transceiver 1201 transmits a second signaling and a second signal in a second time window; CRC comprised in the second signaling is scrambled by the first identifier; the second signaling comprises configuration information of the second signal, the configuration information comprising a time-frequency resource set occupied by the second signal; the target signal is used to trigger the second signal.

In one embodiment, the second transceiver 1201 comprises at least the first six of the antenna 420, the receiver 418, the multi-antenna receiving processor 472, the receiving processor 470, the transmitter 418, the multi-antenna transmitting processor 471, the transmitting processor 416 or the controller/processor 475 in Embodiment 4.

In one embodiment, the first transmitter 1202 comprises at least the first four of the antenna 420, the transmitter 418, the multi-antenna transmitting processor 471, the transmitting processor 416 and the controller/processor 475 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node and the second node in the present application include but are not limited to mobile phones, tablet computers, notebooks, network cards, low-consumption equipment, enhanced MTC (eMTC) terminals, NB-IOT terminals, vehicle-mounted communication equipment, vehicles, automobiles, RSU, aircrafts, airplanes, unmanned aerial vehicles, telecontrolled aircrafts, etc. The base station in the present application includes but is not limited to macrocellular base stations, micro-cellular base stations, home base stations, relay base station, eNB, gNB, Transmitter Receiver Point (TRP), GNSS, relay satellite, satellite base station, airborne base station, RSU, and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first transceiver, transmitting a first characteristic sequence and a target signal; and
a first receiver, monitoring a first signaling in a first time window; and when the first signaling is detected, demodulating a first signal;
wherein a channel occupied by the first characteristic sequence includes a random access (RA)-related channel, a transmission timing of the target signal is related to a transmission timing of the first characteristic sequence; the target signal comprises a first identifier, while the first signal comprises the first identifier and a second identifier, and Cyclic Redundancy Check (CRC) comprised in the first signaling is scrambled by a third identifier; the first signaling comprises configuration information of the first signal, the configuration information comprising a time-frequency resource set occupied by the first signal; the target signal is used to trigger the first signal; the first identifier is a Cell-Radio Network Temporary Identity (C-RNTI), the second identifier is a C-RNTI, and the third identifier is an RNTI different from the first identifier; the first time window is related to a time-domain resource occupied by the target signal.

2. The first node according to claim 1, wherein the first characteristic sequence and the target signal belong to a same message MSGA, with the third identifier being a MSGB-RNTI.

3. The first node according to claim 1, wherein the first transceiver receives a third signal after the first characteristic sequence is transmitted and before the target signal is transmitted; the first characteristic sequence is used to trigger the third signal, the third signal indicating the third identifier.

4. The first node according to claim 1, wherein the first identifier is configured by a first cell, while the second identifier and third identifier are configured by a second cell, the first cell being different from the second cell; a first radio resource is used to determine a first reference signal resource, the first radio resource comprising at least one of a time-domain resource occupied by the first characteristic sequence, a frequency-domain resource occupied by the first characteristic sequence or a preamble index of the first characteristic sequence; or, the target signal comprises a first information element, the first information element in the target signal being used to indicate a first reference signal resource; the first reference signal resource is maintained by the second cell.

5. The first node according to claim 4, wherein the first transceiver receives a first information block, the first information block being used to indicate M1 candidate reference signal resources; and the first transceiver selects the first reference signal resource from the M1 candidate reference signal resources; the first reference signal resource is a candidate reference signal resource among the M1 candidate reference signal resources; a transmitter of the first information block is the first cell; M1 is a positive integer greater than 1.

6. The first node according to claim 1, wherein the first transceiver receives a second information block, the second information block indicating a target reference signal resource group; and the first transceiver measures the target reference signal resource group, where a channel quality of each reference signal resource in the target reference signal resource group is lower than a first threshold, and a first counter is incremented by 1; the target reference signal resource group comprises at least one reference signal resource, the first counter reaches a first trigger value, and a transmission of the first characteristic sequence is triggered.

7. The first node according to claim 1, wherein the action of demodulating a first signal comprises attempting to recover a first MAC Protocol Data Unit (PDU), the first MAC PDU comprising the first identifier and the second identifier; only when the first MAC PDU is recovered will it be determined that a random access (RA) procedure to which the first characteristic sequence belongs is successful.

8. The first node according to claim 1, wherein a meaning of the sentence that a transmission timing of the target signal is related to a transmission timing of the first characteristic sequence comprises: a transmission timing of the first characteristic sequence plus a timing advance is used to determine a slot synchronization timing, with a transmission timing of the target signal being based on the slot synchronization timing, and the timing advance being indicated by a Random Access Response (RAR) corresponding to the first characteristic sequence; the transmission timing of the first characteristic sequence is based on a downlink synchronization.

9. The first node according to claim 1, wherein the target signal and the first signal belong to a same RA procedure.

10. The first node according to claim 1, wherein the first characteristic sequence occupies a first time-frequency resource set, the first time-frequency resource set belonging to a first time-frequency resource pool, the first time-frequency resource pool only being used for a PRACH transmission resulting from mobility; the PRACH transmission resulting from mobility comprises at least one of a PRACH transmission resulting from a Beamlink Failure (BLF) or a PRACH transmission resulting from a triggering of L1/L2 inter-cell handover.

11. A second node for wireless communications, comprising:
a second transceiver, receiving a first characteristic sequence and a target signal; and
a first transmitter, transmitting a first signaling in a first time window; and transmitting a first signal;
wherein a channel occupied by the first characteristic sequence includes a random access (RA)-related channel, a transmission timing of the target signal is related to a transmission timing of the first characteristic sequence; the target signal comprises a first identifier, while the first signal comprises the first identifier and a second identifier, and
CRC comprised in the first signaling is scrambled by a third identifier; the first signaling comprises configuration information of the first signal, the configuration information comprising a time-frequency resource set occupied by the first signal; the target signal is used to trigger the first signal; the first identifier is a C-RNTI, the second identifier is a C-RNTI, and the third identifier is an RNTI different from the first identifier; the first time window is related to a time-domain resource occupied by the target signal.

12. The second node according to claim 11, wherein the first characteristic sequence and the target signal belong to a same message MSGA, with the third identifier being a MSGB-RNTI.

13. The second node according to claim 11, wherein the second transceiver transmits a third signal after the first characteristic sequence is received and before the target signal is received; the first characteristic sequence is used to trigger the third signal, the third signal indicating the third identifier.

14. The second node according to claim 11, wherein the first identifier is configured by a first cell, while the second identifier and third identifier are configured by a second cell, the first cell being different from the second cell; a first radio resource is used to determine a first reference signal resource, the first radio resource comprising at least one of a time-domain resource occupied by the first characteristic sequence, a frequency-domain resource occupied by the first characteristic sequence or a preamble index of the first characteristic sequence; or, the target signal comprises a first information element, the first information element in the target signal being used to indicate a first reference signal resource; the first reference signal resource is maintained by the second cell.

15. The second node according to claim 14, wherein the second transceiver transmits a first information block, the first information block being used to indicate M1 candidate reference signal resources; the first reference signal resource is a candidate reference signal resource among the M1 candidate reference signal resources; a transmitter of the first information block is the first cell; M1 is a positive integer greater than 1.

16. The second node according to claim 11, wherein the second transceiver transmits a second information block, the second information block indicating a target reference signal resource group; a transmitter of the first characteristic sequence is a first node, the first node measuring the target reference signal resource group, where a channel quality of each reference signal resource in the target reference signal resource group is lower than a first threshold, and a first counter of the first node is incremented by 1; the target reference signal resource group comprises at least one reference signal resource, the first counter reaches a first trigger value, and the first characteristic sequence is triggered.

17. The second node according to claim 11, wherein the second transceiver determines that the first identifier is occupied; and the second transceiver transmits a second signaling and a second signal in a second time window; CRC comprised in the second signaling is scrambled by the first identifier; the second signaling comprises configuration information of the second signal, the configuration information comprising a time-frequency resource set occupied by the second signal; the target signal is used to trigger the second signal.

18. The second node according to claim 11, wherein a meaning of the sentence that a transmission timing of the target signal is related to a transmission timing of the first characteristic sequence comprises: a transmission timing of the first characteristic sequence plus a timing advance is used to determine a slot synchronization timing, with a transmission timing of the target signal being based on the slot synchronization timing, and the timing advance being indicated by a Random Access Response (RAR) corresponding to the first characteristic sequence; the transmission timing of the first characteristic sequence is based on a downlink synchronization.

19. The second node according to claim 11, wherein the target signal and the first signal belong to a same RA procedure.

20. A method in a first node for wireless communications, comprising:
transmitting a first characteristic sequence and a target signal; and
monitoring a first signaling in a first time window; and when the first signaling is detected, demodulating a first signal;
wherein a channel occupied by the first characteristic sequence includes a random access (RA)-related channel, a transmission timing of the target signal is related to a transmission timing of the first characteristic sequence; the target signal comprises a first identifier, while the first signal comprises the first identifier and a second identifier, and Cyclic Redundancy Check (CRC) comprised in the first signaling is scrambled by a third identifier; the first signaling comprises configuration information of the first signal, the configuration information comprising a time-frequency resource set occupied by the first signal; the target signal is used to trigger the first signal; the first identifier is a C-RNTI, the second identifier is a C-RNTI, and the third identifier is an RNTI different from the first identifier; the first time window is related to a time-domain resource occupied by the target signal.
